(19) United States
(12) Patent Application Publication
(10) Pub. No.: US 2025/0383068 A1
(43) Pub. Date: Dec. 18, 2025

(54) ILLUMINATION SYSTEM

(71) Applicant: Japan Display Inc., Tokyo (JP)

(72) Inventor: Hiroyuki WAKANA, Tokyo (JP)

(21) Appl. No.: 19/316,613

(22) Filed: Sep. 2, 2025

Related U.S. Application Data
(63) Continuation of application No. PCT/JP2024/000893, filed on Jan. 16, 2024.

(30) Foreign Application Priority Data
Mar. 8, 2023 (JP) 2023-035795

(51) Int. Cl. F21V 14/00

(52) U.S. Cl. CPC F21V 14/003

(57) ABSTRACT

According to an aspect, an illumination system includes an illumination device controllable with respect to a diffusion degree of light emitted from a light source, and a control device including a motion sensor and configured to control the diffusion degree of the illumination device in accordance with output from the motion sensor.

### CROSS-REFERENCE TO RELATED APPLICATION

This application claims the benefit of priority from Japanese Patent Application No. 2023-035795 filed on Mar. 8, 2023 and International Patent Application No. PCT/JP2024/000893 filed on Jan. 16, 2024, the entire contents of which are incorporated herein by reference.

### BACKGROUND

### 1. Technical Field

What is disclosed herein relates to an illumination system.

### 2. Description of the Related Art

In a conventional illumination instrument, a light source such as an LED is combined with a thin lens provided with a prism pattern, and the distance between the light source and the thin lens is changed to change a light distribution angle. Furthermore, an illumination instrument is disclosed (refer to Japanese Patent Application Laid-open Publication No. H02-065001, for example) in which the front of a transparent light bulb is covered by a liquid crystal light adjustment element, and the transmittance of a liquid crystal layer is changed to switch between directly-reaching light and scattering light.

For example, in an illumination device including a liquid crystal cell for p-wave polarization and a liquid crystal cell for s-wave polarization, the diffusion degree of light in two directions can be controlled by driving the respective liquid crystal cells. Improvement of usability in diffusion degree adjustment of such an illumination device is desired. For example, in a conventional adjustment method in which the diffusion degree is adjusted by detecting a touch position on the screen of a terminal device such as a smartphone or a tablet, when, for example, the terminal device is held with one hand and the screen is operated with a finger of the same hand, operation may become unstable, thereby making fine adjustment difficult. Furthermore, when, for example, the terminal device is held with one hand and the screen is operated with a finger of the other hand, both hands become occupied, thereby degrading operation efficiency.

For the foregoing reasons, there is a need for an illumination system capable of improving usability in diffusion degree adjustment of an illumination device.

### SUMMARY

According to an aspect, an illumination system includes an illumination device controllable with respect to a diffusion degree of light emitted from a light source, and a control device including a motion sensor and configured to control the diffusion degree of the illumination device in accordance with output from the motion sensor.

### BRIEF DESCRIPTION OF THE DRAWINGS

FIG. 1A is a side view illustrating an example of an illumination device according to an embodiment;

FIG. 1B is a perspective view illustrating an example of an optical element according to the embodiment;

FIG. 2 is a schematic plan view of a first substrate when viewed in a Dz direction;

FIG. 3 is a schematic plan view of a second substrate when viewed in the Dz direction;

FIG. 4 is a see-through diagram of a liquid crystal cell in which the first substrate and the second substrate are stacked in the Dz direction;

FIG. 5 is a cross-sectional view along line A-A′ illustrated in FIG. 4;

FIG. 6A is a diagram illustrating the alignment direction of an alignment film of the first substrate;

FIG. 6B is a diagram illustrating the alignment direction of an alignment film of the second substrate;

FIG. 7 is a multilayered structure diagram of the optical element according to the embodiment;

FIG. 8A is a conceptual diagram for description of change in shape of light by the optical element according to the embodiment;

FIG. 8B is a conceptual diagram for description of change in shape of light by the optical element according to the embodiment;

FIG. 8C is a conceptual diagram for description of change in shape of light by the optical element according to the embodiment;

FIG. 8D is a conceptual diagram for description of change in shape of light by the optical element according to the embodiment;

FIG. 9 is a conceptual diagram for conceptually describing control of the light diffusion degree of the illumination device according to the embodiment;

FIG. 10 is a schematic view illustrating an example of the configuration of an illumination system according to the embodiment;

FIG. 11 is an exterior diagram illustrating an example of a control device according to the embodiment;

FIG. 12 is a conceptual diagram illustrating an example of a touch detection region of a touch sensor;

FIG. 13 is a diagram illustrating an example of a control block configuration of the control device according to a first embodiment;

FIG. 14 is a diagram illustrating an example of a control block configuration of the illumination device according to the first embodiment;

FIG. 15A is a conceptual diagram illustrating a gyro sensor as an example of a motion sensor 40 mounted on the control device according to the first embodiment;

FIG. 15B is a conceptual diagram illustrating a geomagnetic sensor as an example of the motion sensor 40 mounted on the control device according to the first embodiment;

FIG. 15C is a conceptual diagram illustrating an acceleration sensor as an example of the motion sensor 40 mounted on the control device according to the first embodiment;

FIG. 16A is a conceptual diagram illustrating a first example of the display aspect of an illumination control application screen on the control device according to the first embodiment;

FIG. 16B is a conceptual diagram illustrating a second example of the display aspect of the illumination control application screen on the control device according to the first embodiment;

FIG. 17A is a first diagram illustrating the relation between an effective range of a tilt angle and a diffusion degree adjustment range in diffusion degree control according to the first embodiment;

FIG. 17B is a second diagram illustrating the relation between the effective range of the tilt angle and the diffusion degree adjustment range in diffusion degree control according to the first embodiment;

FIG. 17C is a third diagram illustrating the relation between the effective range of the tilt angle and the diffusion degree adjustment range in diffusion degree control according to the first embodiment;

FIG. 17D is a fourth diagram illustrating the relation between the effective range of the tilt angle and the diffusion degree adjustment range in diffusion degree control according to the first embodiment;

FIG. 17E is a fifth diagram illustrating the relation between the effective range of the tilt angle and the diffusion degree adjustment range in diffusion degree control according to the first embodiment;

FIG. 18A is a line diagram illustrating a first example of tilt angle-to-diffusion degree setting value conversion characteristics in diffusion degree control according to the first embodiment;

FIG. 18B is a line diagram illustrating a second example of tilt angle-to-diffusion degree setting value conversion characteristics in diffusion degree control according to the first embodiment;

FIG. 19 is a flowchart illustrating an example of initial setting processing in diffusion degree control according to the first embodiment;

FIG. 20 is a flowchart illustrating an example of an overall sequence of diffusion degree control processing according to the first embodiment;

FIG. 21 is a flowchart illustrating an example of diffusion degree adjustment range setting processing in diffusion degree control according to the first embodiment;

FIG. 22 is a flowchart illustrating an example of tilt angle-to-diffusion degree conversion processing in diffusion degree control according to the first embodiment;

FIG. 23A is a first diagram illustrating the relation between the effective range of the tilt angle and the diffusion degree adjustment range in diffusion degree control according to a second embodiment;

FIG. 23B is a second diagram illustrating the relation between the effective range of the tilt angle and the diffusion degree adjustment range in diffusion degree control according to the second embodiment;

FIG. 23C is a third diagram illustrating the relation between the effective range of the tilt angle and the diffusion degree adjustment range in diffusion degree control according to the second embodiment;

FIG. 23D is a fourth diagram illustrating the relation between the effective range of the tilt angle and the diffusion degree adjustment range in diffusion degree control according to the second embodiment;

FIG. 24 is a flowchart illustrating an example of initial setting processing in diffusion degree control according to the second embodiment;

FIG. 25 is a flowchart illustrating an example of an overall sequence of diffusion degree control processing according to the second embodiment; and

FIG. 26 is a flowchart illustrating an example of tilt angle-to-diffusion degree conversion processing in diffusion degree control according to the second embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

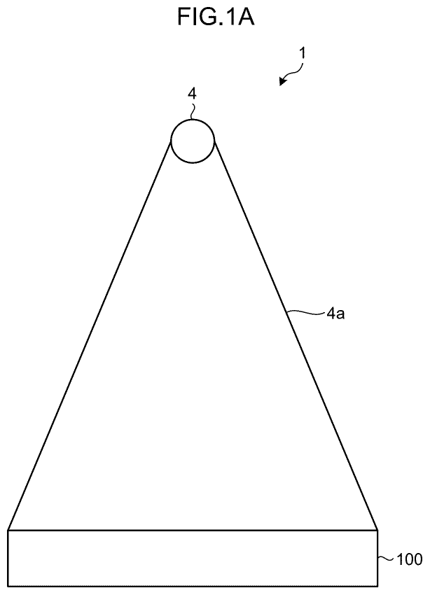

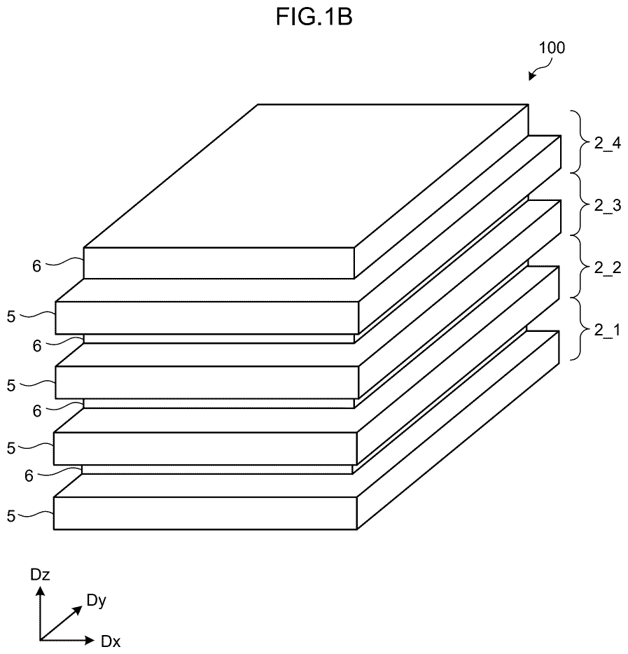

FIG. 1A is a side view illustrating an example of an illumination device 1 according to an embodiment. FIG. 1B is a perspective view illustrating an example of an optical element 100 according to the embodiment. As illustrated in FIG. 1A, the illumination device 1 includes a light source 4, a reflector 4a, and the optical element 100. As illustrated in FIG. 1B, the optical element 100 includes a first liquid crystal cell 2_1, a second liquid crystal cell 2_2, a third liquid crystal cell 2_3, and a fourth liquid crystal cell 2_4. The light source 4 is configured with, for example, a light emitting diode (LED). The reflector 4a is a component that condenses light from the light source 4 to the optical element 100.

In FIG. 1B, a Dz direction indicates the emission direction of light from the light source 4 and the reflector 4a. The optical element 100 has a configuration in which the first liquid crystal cell 2_1, the second liquid crystal cell 2_2, the third liquid crystal cell 2_3, and the fourth liquid crystal cell 2_4 are stacked in the Dz direction. In the present disclosure, the optical element 100 has a configuration in which the first liquid crystal cell 2_1, the second liquid crystal cell 2_2, the third liquid crystal cell 2_3, and the fourth liquid crystal cell 2_4 are sequentially stacked from the light source 4 side (lower side in FIG. 1B). In FIG. 1B, one direction in a plane orthogonal to the Dz direction and parallel to stacking surfaces of the first liquid crystal cell 2_1, the second liquid crystal cell 2_2, the third liquid crystal cell 2_3, and the fourth liquid crystal cell 2_4 is defined as a Dx direction (first direction), and a direction orthogonal to both the Dx direction and the Dz direction is defined as a Dy direction (second direction).

The first liquid crystal cell 2_1, the second liquid crystal cell 2_2, the third liquid crystal cell 2_3, and the fourth liquid crystal cell 2_4 have the same configuration. In the present disclosure, the first liquid crystal cell 2_1 and the fourth liquid crystal cell 2_4 are liquid crystal cells for p-wave polarization. The second liquid crystal cell 2_2 and the third liquid crystal cell 2_3 are liquid crystal cells for s-wave polarization. Hereinafter, the first liquid crystal cell 2_1, the second liquid crystal cell 2_2, the third liquid crystal cell 2_3, and the fourth liquid crystal cell 2_4 are also collectively referred to as “liquid crystal cells 2”.

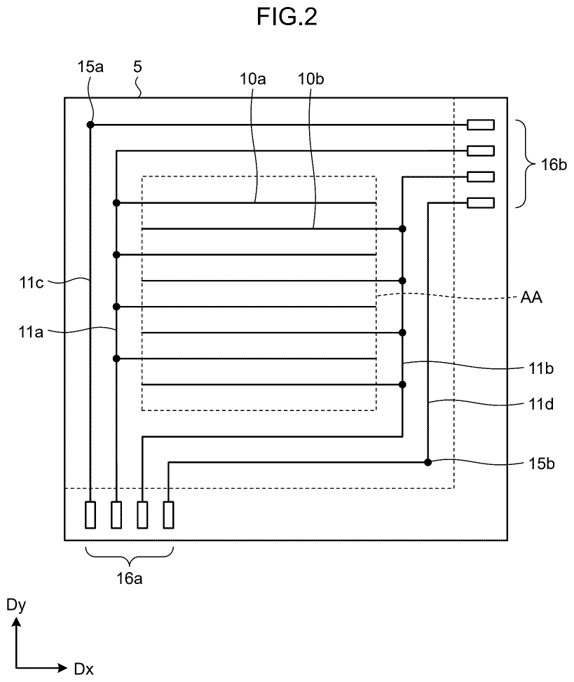

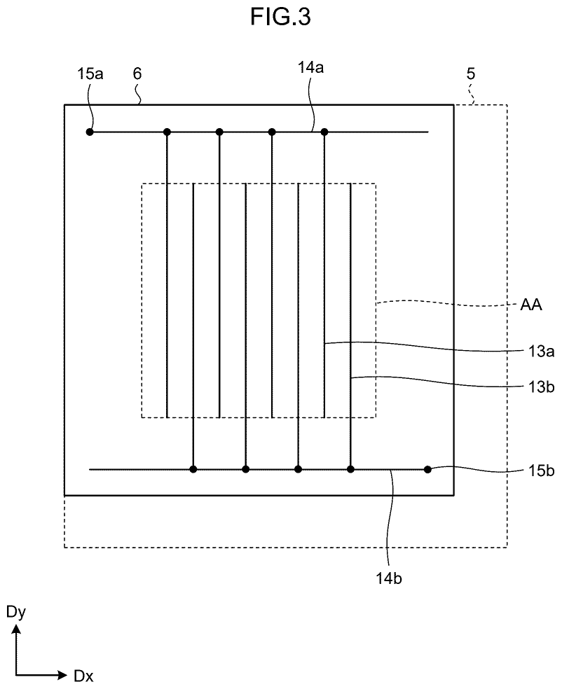

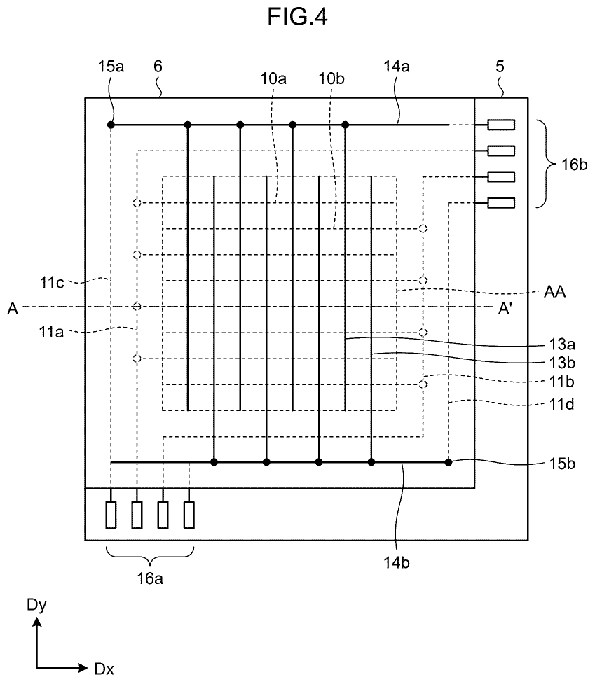

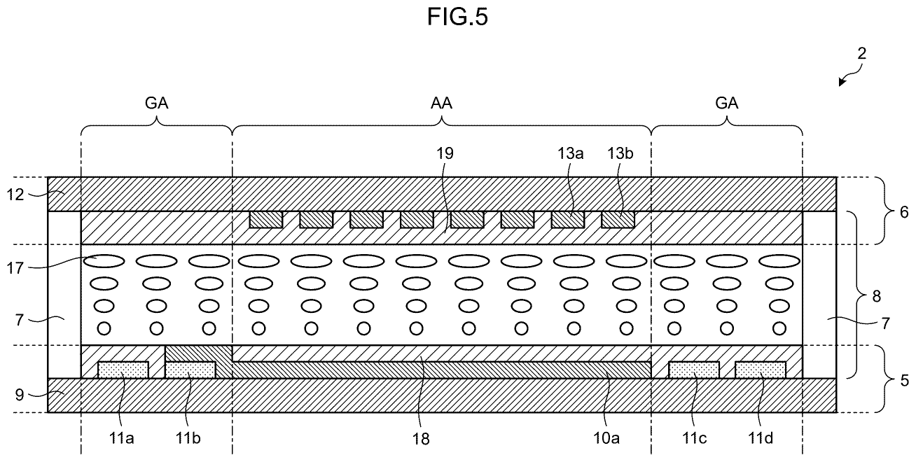

Each liquid crystal cell 2 includes a first substrate 5 and a second substrate 6. FIG. 2 is a schematic plan view of the first substrate 5 when viewed in the Dz direction. FIG. 3 is a schematic plan view of the second substrate 6 when viewed in the Dz direction. In FIG. 3, drive electrodes are visible through the substrates, but for clarity, the drive electrodes and wiring lines are illustrated with solid lines. FIG. 4 is a see-through view of a liquid crystal cell in which the first substrate 5 and the second substrate 6 are stacked in the Dz direction. In FIG. 4 as well, for clarity, drive electrodes and wiring lines on the second substrate side are illustrated with solid lines, and drive electrodes and wiring lines on the first substrate side are illustrated with dotted lines. FIG. 5 is a sectional view along line A-A′ illustrated in FIG. 4. FIGS. 2, 3, 4, and 5 exemplarily illustrate the third liquid crystal cell 2_3 and the fourth liquid crystal cell 2_4 in which drive electrodes 10a and 10b of the first substrate 5 extend in the Dx direction and drive electrodes 13a and 13b of the second substrate 6 extend in the Dy direction.

As illustrated in FIG. 5, the liquid crystal cell 2 includes a liquid crystal layer 8 sealed around its periphery by a sealing member 7 between the first substrate 5 and the second substrate 6.

The liquid crystal layer 8 modulates light passing through the liquid crystal layer 8 in accordance with the state of electric field. As liquid crystal molecules, positive-type nematic liquid crystals are used, but other liquid crystals with the same effects may be used.

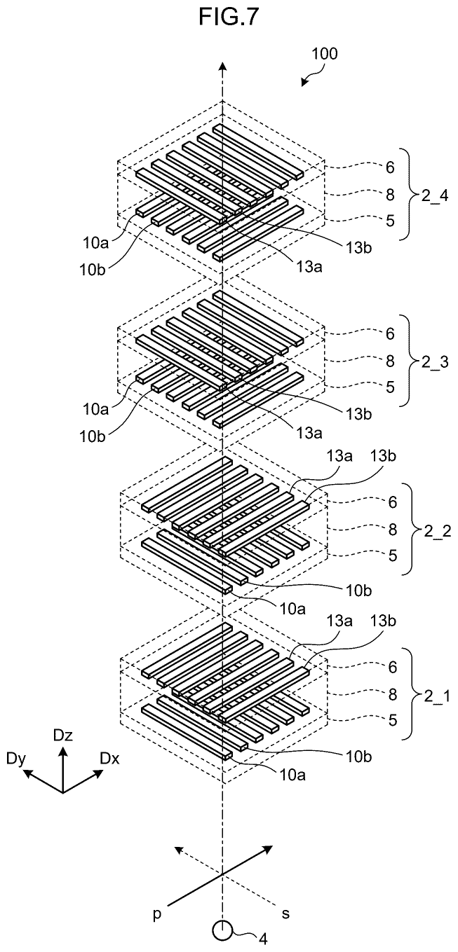

As illustrated in FIG. 2, the drive electrodes 10a and 10b, metal lines 11a and 11b, and metal lines 11c and 11d are provided on the liquid crystal layer 8 side of a base member 9 of the first substrate 5. The metal lines 11a and 11b supply drive voltage that is applied to the drive electrodes 10a and 10b, and the metal lines 11c and 11d supply drive voltage that is applied to the drive electrodes 13a and 13b (refer to FIG. 3) provided on the second substrate 6 to be described later. The metal lines 11a, 11b, 11c, and 11d are provided in a wiring layer of the first substrate 5. The metal lines 11a, 11b, 11c, and 11d are provided to be spaced apart in the wiring layer on the first substrate 5. Hereinafter, the drive electrodes 10a and 10b are simply referred to as “drive electrodes 10” in some cases. The metal lines 11a, 11b, 11c, and 11d are referred to as “first metal lines 11” in some cases. As illustrated in FIGS. 2 and 7, in the third liquid crystal cell 2_3 and the fourth liquid crystal cell 2_4, the drive electrodes 10 on the first substrate 5 extend in the Dx direction. In the first liquid crystal cell 2_1 and the second liquid crystal cell 2_2, the drive electrodes 10 on the first substrate 5 extend in the Dy direction.

As illustrated in FIG. 3, the drive electrodes 13a and 13b, and a plurality of metal lines 14a and 14b that supply drive voltage applied to the drive electrodes 13 are provided on the liquid crystal layer 8 side of a base member 12 of the second substrate 6 illustrated in FIG. 5. The metal lines 14a and 14b are provided in a wiring layer of the second substrate 6. The metal lines 14a and 14b are provided to be spaced apart in the wiring layer on the second substrate 6. Hereinafter, the drive electrodes 13a and 13b are simply referred to as “drive electrodes 13” in some cases. The metal lines 14a and 14b are referred to as “second metal lines 14” in some cases. As illustrated in FIGS. 3 and 7, in the third liquid crystal cell 2_3 and the fourth liquid crystal cell 2_4, the drive electrodes 13 on the second substrate 6 extend in the Dy direction. In the first liquid crystal cell 2_1 and the second liquid crystal cell 2_2, the drive electrodes 13 on the second substrate 6 extend in the Dx direction.

The drive electrodes 10 and the drive electrodes 13 are light-transmitting electrodes formed of a light-transmitting conductive material (light-transmitting conductive oxide) such as indium tin oxide (ITO). The first substrate 5 and the second substrate 6 are light-transmitting substrates such as glass or resin. The first metal lines 11 and the second metal lines 14 are formed of at least one metallic material selected from aluminum (Al), copper (Cu), silver (Ag), molybdenum (Mo), and alloys thereof. The first metal lines 11 and the second metal lines 14 may be stacked bodies of a plurality of layers using one or more of these metallic materials. At least one metallic material selected from aluminum (Al), copper (Cu), silver (Ag), molybdenum (Mo), and alloys thereof has lower resistance than light-transmitting conductive oxide such as ITO.

The metal line 11c of the first substrate 5 and the metal line 14a of the second substrate 6 are coupled by a conduction part 15a made of, for example, conductive paste. The metal line 11d of the first substrate 5 and the metal line 14b of the second substrate 6 are coupled by a conduction part 15b made of, for example, conductive paste.

Coupling (flex-on-board) terminal parts 16a and 16b that are coupled to non-illustrated flexible printed circuits (FPC) are provided in regions on the first substrate 5, which do not overlap the second substrate 6 when viewed in the Dz direction. The coupling terminal parts 16a and 16b each include four coupling terminals corresponding to the metal lines 11a, 11b, 11c, and 11d, respectively.

The coupling terminal parts 16a and 16b are provided in the wiring layer of the first substrate 5. Drive voltage to be applied to the drive electrodes 10a and 10b on the first substrate 5 and the drive electrodes 13a and 13b on the second substrate 6 is supplied to the liquid crystal cell 2 from an FPC coupled to the coupling terminal part 16a or the coupling terminal part 16b. Hereinafter, the coupling terminal parts 16a and 16b are simply referred to as “coupling terminal parts 16” in some cases.

As illustrated in FIG. 4, in the liquid crystal cell 2, the first substrate 5 and the second substrate 6 are stacked in the Dz direction (irradiation direction of light), and the drive electrodes 10 on the first substrate 5 intersect the drive electrodes 13 on the second substrate 6 when viewed in the Dz direction. In the liquid crystal cell 2 thus configured, the alignment direction of liquid crystal molecules 17 in the liquid crystal layer 8 can be controlled by supplying drive voltage to the drive electrodes 10 on the first substrate 5 and the drive electrodes 13 on the second substrate 6. A region in which the alignment direction of the liquid crystal molecules 17 in the liquid crystal layer 8 can be controlled is referred to as an “effective region AA”. The refractive index distribution of the liquid crystal layer 8 is changed in the effective region AA, whereby the diffusion degree of light transmitted through the effective region AA of the liquid crystal cell 2 can be controlled. A region outside the effective region AA, where the liquid crystal layer 8 is sealed by the sealing member 7, is referred to as a “peripheral region GA” (refer to FIG. 5).

As illustrated in FIG. 5, the drive electrodes 10 (in FIG. 5, the drive electrode 10a) in the effective region AA of the first substrate 5 are covered by an alignment film 18. The drive electrodes 13 (in FIG. 5, the drive electrodes 13a and 13b) in the effective region AA of the second substrate 6 are covered by an alignment film 19. The alignment direction of the liquid crystal molecules is different between the alignment film 18 and the alignment film 19.

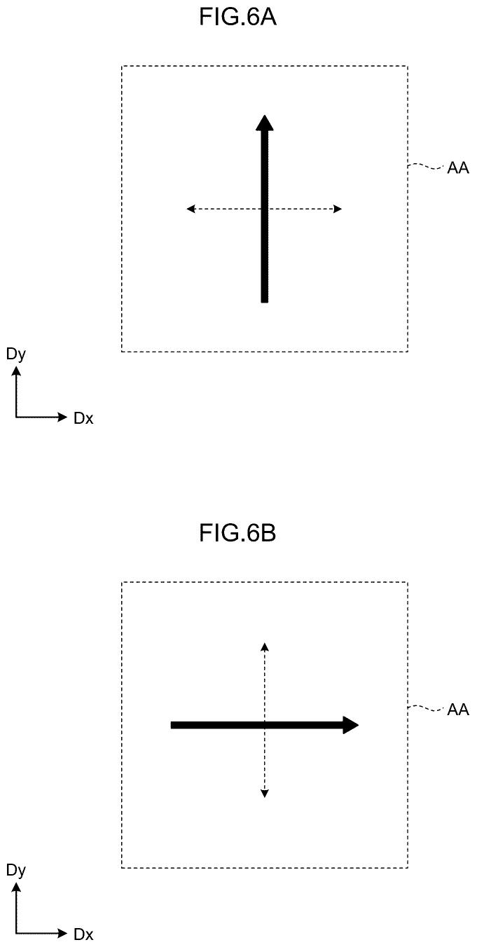

FIG. 6A is a diagram illustrating the alignment direction of the alignment film of the first substrate 5. FIG. 6B is a diagram illustrating the alignment direction of the alignment film of the second substrate 6.

As illustrated in FIGS. 6A and 6B, the alignment direction of the alignment film 18 of the first substrate 5 and the alignment direction of the alignment film 19 of the second substrate 6 are directions intersecting each other in plan view. Specifically, as illustrated with a solid arrow in FIG. 6A, the alignment direction of the alignment film 18 of the first substrate 5 is orthogonal to the extending direction of the drive electrodes 10a and 10b, which is illustrated with a dashed arrow in FIG. 6A. As illustrated with a solid arrow in FIG. 6B, the alignment direction of the alignment film 19 of the second substrate 6 is orthogonal to the extending direction of the drive electrodes 13a and 13b, which is illustrated with a dashed arrow in FIG. 6B. In the following description, the extending directions of the drive electrodes 10 and 13 are orthogonal to the alignment directions of the alignment films 18 and 19 covering them, but these may intersect at an angle other than being orthogonal, for example, in the angle range of 85° to 90°. The drive electrodes 10 on the first substrate 5 side and the drive electrodes 13 on the second substrate 6 side are preferably orthogonal to each other but may intersect, for example, in the angle range of 85° to 90°. The alignment directions of the alignment films 18 and 19 are formed by rubbing processing or light alignment processing.

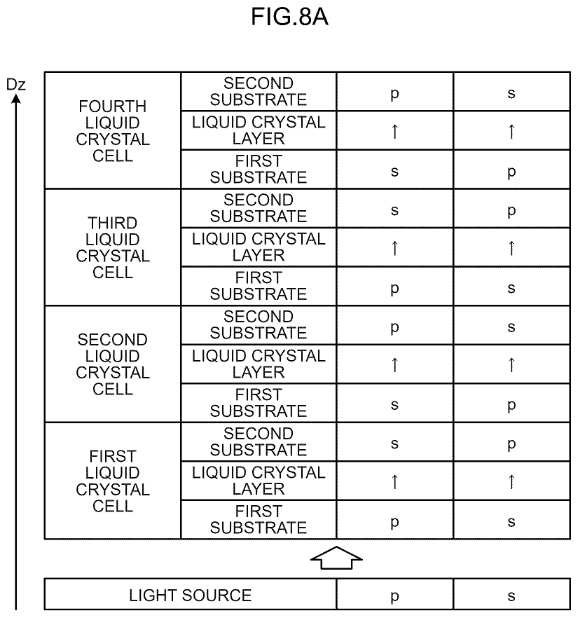

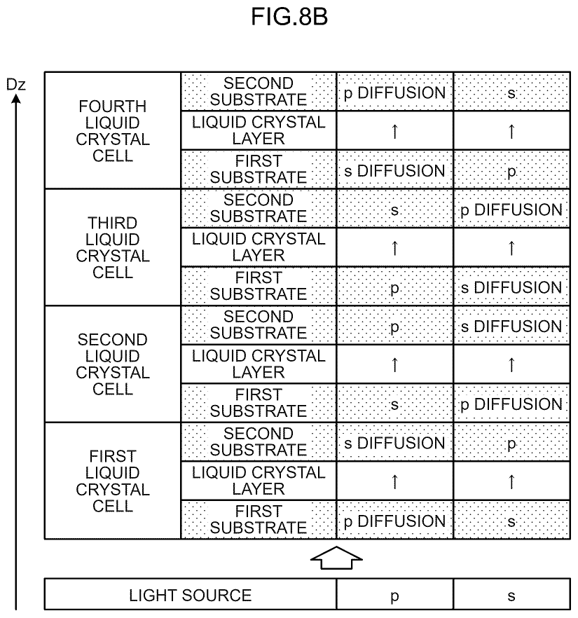

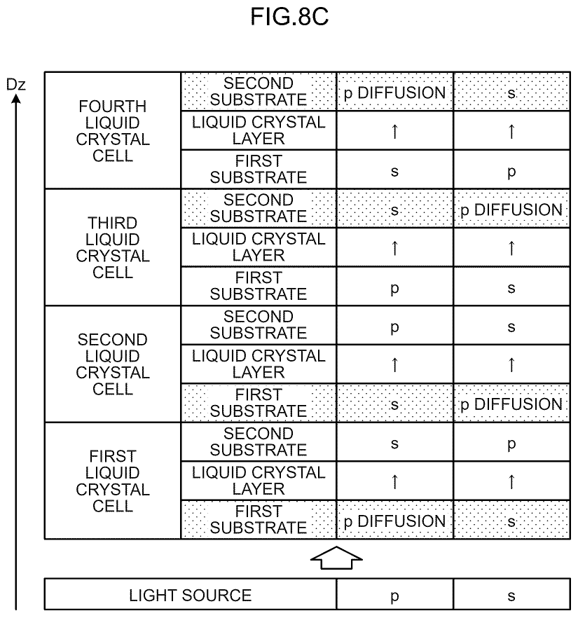

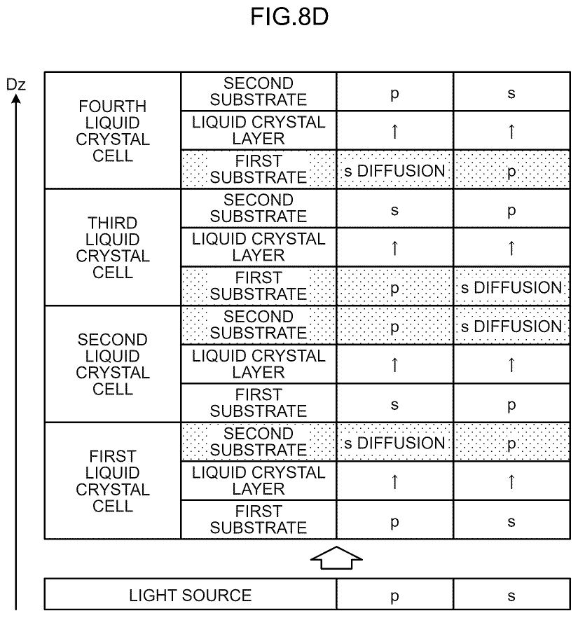

A mechanism for changing the shape of light by using the liquid crystal cells 2 (the first liquid crystal cell 2_1, the second liquid crystal cell 2_2, the third liquid crystal cell 2_3, and the fourth liquid crystal cell 2_4) will be described below. FIG. 7 is a multilayered structure diagram of the optical element 100 according to the embodiment. FIGS. 8A, 8B, 8C, and 8D are conceptual diagrams for description of change in shape of light by the optical element 100 according to the embodiment. FIGS. 8A, 8B, 8C, and 8D illustrate examples in which potential difference is generated between the drive electrodes of hatched substrates of the liquid crystal cells 2.

As illustrated in FIG. 7, the optical element 100 is provided on the optical axis of the light source 4, which is illustrated with a dashed and single-dotted line, and as described above, the first liquid crystal cell 2_1, the second liquid crystal cell 2_2, the third liquid crystal cell 2_3, and the fourth liquid crystal cell 2_4 are sequentially stacked from the light source 4 side (lower side in FIG. 7). The third liquid crystal cell 2_3 and the fourth liquid crystal cell 2_4 are stacked in a state of being rotated by 90° relative to the first liquid crystal cell 2_1 and the second liquid crystal cell 2_2.

In each liquid crystal cell 2, the alignment direction of the alignment film on the first substrate 5 side and the second substrate 6 side intersect each other as illustrated in FIGS. 6A and 6B. Accordingly, from the first substrate 5 side toward the second substrate 6 side, the orientation of the liquid crystal molecules in the liquid crystal layer 8 gradually changes from the Dx direction to the Dy direction (or from the Dy direction to the Dx direction), and the polarized light component of transmitted light rotates along with the change. Specifically, in the liquid crystal cell 2, the polarized light component, which is a p-polarized light component on the first substrate 5 side, changes to an s-polarized light component as distance from the second substrate 6 decreases, and the polarized light component, which is an s-polarized light component on the first substrate 5 side, changes to a p-polarized light component as distance from the second substrate 6 decreases. This rotation of the polarized light component may be referred to as optical rotation.

FIG. 8A illustrates a state in which no potential is generated between adjacent electrodes in each liquid crystal cell 2. In this case, only optical rotation occurs in each liquid crystal cell 2 and no polarized light component is diffused.

As illustrated in FIG. 8B, for example, when potential difference is generated between the drive electrodes 10a and 10b on the first substrate 5 in the first liquid crystal cell 2_1 to induce a horizontal electric field, the liquid crystal molecules between the electrodes are aligned in a circular arc shape, and thus, refractive index distribution is formed in the Dx direction in the liquid crystal layer 8. As light from the light source 4 is transmitted in this state, the above-described refractive index distribution acts on the polarized light component (in FIG. 8B, p-polarized light component) parallel to the Dx direction, and therefore, the p-polarized light component diffuses in the Dx direction.

In addition, when potential difference is generated between the drive electrodes 13a and 13b on the second substrate 6 side in the first liquid crystal cell 2_1, refractive index distribution is formed in the Dy direction on the second substrate 6 side, and accordingly, the s-polarized light component diffuses in the Dy direction on the second substrate 6 side. Specifically, the polarized light component having changed from a p-polarized light component to an s-polarized light component during passing through the liquid crystal layer 8 in the first liquid crystal cell 2_1 diffuses in the Dy direction as well. However, the s-polarized light component at incidence on the first liquid crystal cell 2_1 optically rotates during passing through the liquid crystal layer 8 but intersects each refractive index distribution, and accordingly, only optically rotates without diffusing and passes through the first liquid crystal cell 2_1.

The s-polarized light component at incidence on the first liquid crystal cell 2_1 changes to a p-polarized light component after passing through the first liquid crystal cell 2_1, and the second liquid crystal cell 2_2 acts on this p-polarized light component. Specifically, as illustrated in FIGS. 8A and 8B, the first liquid crystal cell 2_1 acts on the p-polarized light component of light incident on the optical element 100, and the second liquid crystal cell 2_2 acts on the s-polarized light component thereof. Since the third liquid crystal cell 2_3 and the fourth liquid crystal cell 2_4 are provided with rotation by 90° relative to the first liquid crystal cell 2_1 and the second liquid crystal cell 2_2, polarized light components on which they act are switched by 90°. Specifically, the third liquid crystal cell 2_3 acts on the s-polarized light component at incidence on the optical element 100, and the fourth liquid crystal cell 2_4 acts on the p-polarized light component at incidence on the optical element 100.

As illustrated in FIG. 8C, in the optical element, it is possible to act on the p-polarized light component by providing potential difference between drive electrodes extending in the Dy direction in each liquid crystal cell 2 (between the drive electrodes 10a and 10b of the first substrate 5 in the first liquid crystal cell 2_1 and the second liquid crystal cell 2_2 and between the drive electrodes 13a and 13b of the second substrate 6 in the third liquid crystal cell 2_3 and the fourth liquid crystal cell 2_4), thereby increasing the shape of light mainly in the Dx direction. This effect may be referred to as horizontal diffusion.

As illustrated in FIG. 8D, it is possible to act on the s-polarized light component by providing potential difference between drive electrodes extending in the Dx direction in each liquid crystal cell 2 (between the drive electrodes 13a and 13b of the second substrate 6 in the first liquid crystal cell 2_1 and the second liquid crystal cell 2_2 and between the drive electrodes 10a and 10b of the first substrate 5 in the third liquid crystal cell 2_3 and the fourth liquid crystal cell 2_4), thereby increasing the shape of light mainly in the Dy direction. This effect may be referred to as vertical diffusion.

The diffusion degree of light in each direction depends on the potential difference between the drive electrodes 10a and 10b (or between the drive electrodes 13a and 13b) adjacent to each other. The spread of light in the direction is maximum (100%) in a case where the potential difference between the drive electrodes 10a and 10b (or between the drive electrodes 13a and 13b) is maximum potential difference (for example, 30 V) defined in advance, and no spread of light (0%) occurs in the direction in a case where no potential difference is generated. Alternatively, the spread of light in the direction is 50% in a case where the potential difference between the drive electrodes 10a and 10b (or between the drive electrodes 13a and 13b) is 50% (for example, 15 V) of the above-described maximum potential difference. In a case where the relation between voltage difference and light spread is not linear, it is possible to set another potential difference instead of 15 V.

In each liquid crystal cell 2, the interval (also referred to as a cell gap) between its substrates (between the first substrate 5 and the second substrate 6) is large and is 10 μm to 50 μm approximately, more preferably at 15 μm to 35 μm approximately, and thus, influence of an electric field formed in one of the substrates on the other substrate side is reduced as much as possible. Drive voltage that generates potential difference between the drive electrodes 10a and 10b (or between the drive electrodes 13a and 13b) adjacent to each other is what is called an alternating-current square wave, thereby preventing burn-in of the liquid crystal molecules.

The alignment directions of the alignment films, the extending directions of the drive electrodes on the substrates, and the angle between them may be modified as appropriate for the entire optical element 100 or each liquid crystal cell 2 in accordance with the characteristics of liquid crystals to be employed and optical characteristics to be intentionally obtained.

In the present embodiment, description is made on the configuration of the optical element 100 in which the four liquid crystal cells of the first liquid crystal cell 2_1, the second liquid crystal cell 2_2, the third liquid crystal cell 2_3, and the fourth liquid crystal cell 2_4 are stacked, but the optical element 100 is not limited to this configuration and may employ, for example, a configuration in which two or three liquid crystal cells 2 are stacked or a configuration in which a plurality of liquid crystal cells 2, five or more liquid crystal cells 2, are stacked.

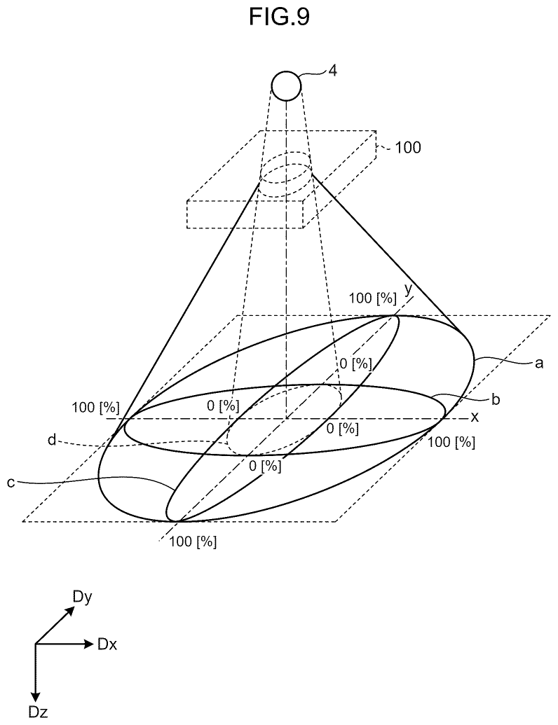

In the present disclosure, in the illumination device 1 with the above-described configuration, light incident on the optical element from the light source 4 is controlled in the two directions of the Dx direction (direction of horizontal diffusion) and the Dy direction (direction of vertical diffusion) by controlling drive voltage of each liquid crystal cell 2. The above-described vertical diffusion and horizontal diffusion may be collectively referred to as light diffusion. Accordingly, the shape of light emitted from the optical element is changed. The shape of light is a light shape that appears on a plane parallel to an emission surface of the optical element, and this may be referred to as a light distribution shape. Hereinafter, control of the light diffusion degree in the present disclosure will be described below with reference to FIG. 9.

FIG. 9 is a conceptual diagram for conceptually describing control of the light diffusion degree of the illumination device 1 according to the embodiment. FIG. 9 illustrates an irradiation area of light on a virtual plane xy orthogonal to the Dz direction. The outline of the actual irradiation area is slightly unclear depending on the distance from the light source 4, a light diffraction phenomenon, and the like.

As described above, the drive voltage is supplied to the drive electrodes 10 and 13 of each liquid crystal cell 2 of the optical element 100 provided on the optical axis of the light source 4, whereby the alignment direction of the liquid crystal molecules 17 in the liquid crystal layer 8 is controlled. Thus, the light distribution shape of light emitted from the optical element 100 is controlled.

Specifically, for example, the light distribution shape in the Dx direction changes with the drive voltage applied to the drive electrodes 10 or drive electrodes 13 extending in the Dy direction in each liquid crystal cell 2 as described above (horizontal diffusion). The light distribution shape in the Dy direction changes with the drive voltage applied to the drive electrodes 10 or drive electrodes 13 extending in the Dx direction in the first to fourth liquid crystal cells (vertical diffusion).

In the present disclosure, the minimum diffusion degrees of the horizontal diffusion and the vertical diffusion are 0% and the maximum diffusion degrees thereof are 100%. More specifically, in a case where the horizontal diffusion degree is 0%, drive electrodes (for example, the drive electrodes 10 extending in the Dy direction on the first substrate 5 in the first liquid crystal cell 2_1) functioning to expand the light distribution state in the Dx direction do not act on the refractive index distribution of the liquid crystal layer 8. In this case, no potential difference is present between the adjacent drive electrodes 10a and 10b or no potential is supplied to the electrodes. On the other hand, in a case where the horizontal diffusion degree is 100%, drive electrodes (for example, the drive electrodes 10 extending in the Dy direction on the first substrate 5 in the first liquid crystal cell 2_1) functioning to expand the light distribution state in the Dx direction maximally act on the refractive index distribution of the liquid crystal layer 8. In this case, the potential difference between the adjacent drive electrodes 10a and 10b is set to the maximum potential difference (for example, 30 V) in the optical element 100. In a case where the horizontal diffusion degree is larger than 0% and smaller than 100%, potential adjusted such that the potential difference between the adjacent drive electrodes 10a and 10b is larger than 0 V and smaller than the maximum potential difference (for example, 30 V) is applied to the electrodes. The same applies to the vertical diffusion.

Outline “a” illustrated in FIG. 9 exemplarily indicates the irradiation area on the virtual plane xy in a case where the horizontal diffusion degree and the vertical diffusion degree are both 100%. Outline “b” illustrated in FIG. 9 exemplarily indicates the irradiation area on the virtual plane xy in a case where the horizontal diffusion degree is 100% and the vertical diffusion degree is 0%. Outline “c” illustrated in FIG. 9 exemplarily indicates the irradiation area in a case where the horizontal diffusion degree is 0% and the vertical diffusion degree is 100%. Outline “d” illustrated in FIG. 9 exemplarily indicates the irradiation area on the virtual plane xy in a case where the horizontal diffusion degree and the vertical diffusion degree are both 0%. In other words, outline “d” indicates the light distribution state when light from the light source 4 is emitted without being controlled by the optical element 100 (or simply transmitted through the optical element 100).

In this manner, in the illumination device 1 with the above-described configuration, it is possible to control the horizontal and vertical diffusion degrees of emission light from the optical element 100 by performing drive voltage control of each liquid crystal cell 2. Accordingly, it is possible to change, on the virtual plane xy, the light distribution shape of emission light from the illumination device 1. Hereinafter, control that changes the light distribution shape of light emitted onto the virtual plane xy by adjusting the horizontal and vertical diffusion degrees of emission light from the illumination device 1 is also referred to as “light distribution control”.

In the present disclosure, the illumination device 1 configured to be subject to light distribution control in the two directions of the Dx and Dy directions is exemplarily described, but the controllable parameters of the illumination device 1 are not limited to light distribution (light spread). For example, the illumination device 1 may be configured to be subject to light adjustment control. In this case, the controllable parameters of the illumination device 1 may include light adjustment (brightness).

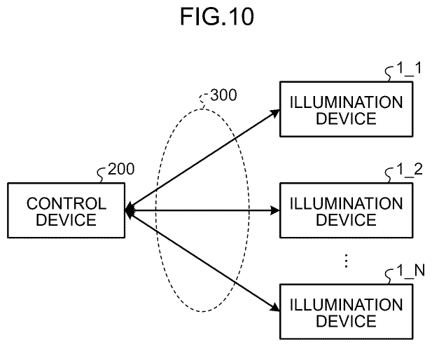

FIG. 10 is a schematic view illustrating an example of the configuration of an illumination system according to the embodiment. The illumination system according to the embodiment includes a plurality of illumination devices 1_1, 1_2, . . . , and 1_N and a control device 200. The control device 200 is, for example, a portable communication terminal device such as a smartphone or a tablet.

Data and various command signals are transmitted bidirectionally between the control device 200 and each of the illumination devices 1_1, 1_2, . . . , and 1_N through a communication means 300. In the present disclosure, the communication means 300 is a wireless communication means of, for example, Bluetooth (registered trademark) or WiFi (registered trademark). Wireless communication may be performed between the control device 200 and each of the illumination devices 1_1, 1_2, . . . , and 1_N through, for example, a predetermined network such as a mobile communication network. Alternatively, each of the illumination devices 1_1, 1_2, . . . , and 1_N and the control device 200 may be coupled in a wired manner to perform wired communication therebetween.

In the example illustrated in FIG. 10, N (N is a natural number equal to or larger than one) illumination devices 1_n (n is a natural number of 1 to N) are exemplified, but the present disclosure is not limited by the number of illumination devices 1. Furthermore, in the present disclosure, an aspect in which the diffusion degree of each illumination device 1 is controlled as a setting parameter of the illumination device 1 will be described below, but the setting parameter is not limited to the diffusion degree. Examples of setting parameters of the illumination device 1 may include the light quantity and color temperature of the illumination device 1.

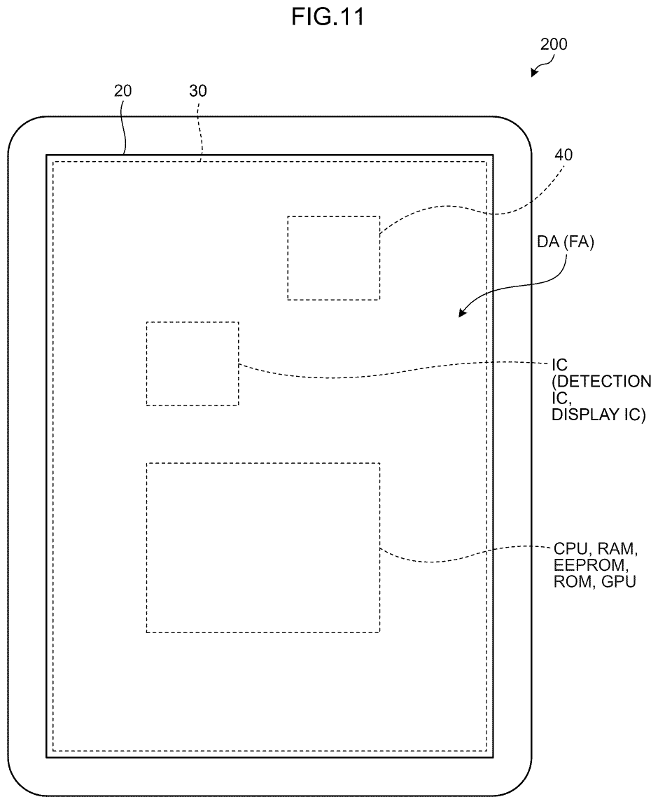

FIG. 11 is an exterior diagram illustrating an example of the control device 200 according to the embodiment. The control device 200 is a display device (touch screen) with a touch detection function in which a display panel 20 and a touch sensor 30 are integrated. The control device 200 includes, as internal constituent components, for example, various ICs such as a detection IC and a display IC, and a central processing unit (CPU), a random access memory (RAM), an electrically erasable programmable read only memory (EEPROM), a read only memory (ROM), and a graphics processing unit (GPU) of a smartphone, a tablet, or the like constituting the control device 200.

The display panel 20 is what is called an in-cell or hybrid device in which the touch sensor 30 is built and integrated. Building and integrating the touch sensor 30 in the display panel 20 includes, for example, sharing some members such as substrates and electrodes used as the display panel 20 and some members such as substrates and electrodes used as the touch sensor 30. The display panel 20 may be what is called an on-cell type device in which the touch sensor 30 is mounted on a display device.

The display panel 20 is, for example, a liquid crystal display panel including a liquid crystal display element. The display panel 20 is not limited thereto but may be, for example, an organic EL display panel (organic light emitting diode (OLED)) or an inorganic EL display panel (micro LED or mini LED).

The touch sensor 30 is, for example, a capacitive touch sensor. The touch sensor 30 is not limited thereto but may be, for example, a touch sensor of a resistance film scheme or a touch sensor of an ultrasonic wave scheme or an optical scheme.

In the present disclosure, the control device 200 includes a motion sensor 40 configured to sense motion (tilt, rotation, and swing) of the control device 200. The motion sensor 40 will be described later.

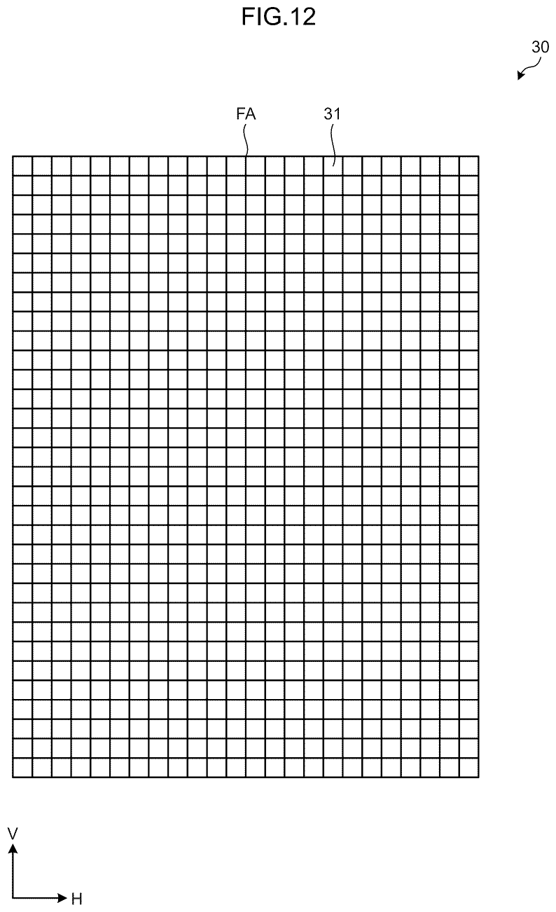

FIG. 12 is a conceptual diagram illustrating an example of a touch detection region of the touch sensor 30. A plurality of detection elements 31 are provided in a detection region FA of the touch sensor 30. The detection elements 31 in the detection region FA of the touch sensor 30 are arranged in an X direction and a Y direction orthogonal to the X direction and provided in a matrix of a row-column configuration. In other words, the touch sensor 30 has the detection region FA overlapping the detection elements 31 arranged in the X direction and the Y direction.

### First Embodiment

Processing of the illumination system in the present disclosure is executed by application software (hereinafter also referred to as “illumination control application”) operating on the control device 200. Configurations and operation for controlling the diffusion degree of light emitted from the light source 4 of the illumination device 1 in the control device 200 of an illumination system according to a first embodiment will be described below.

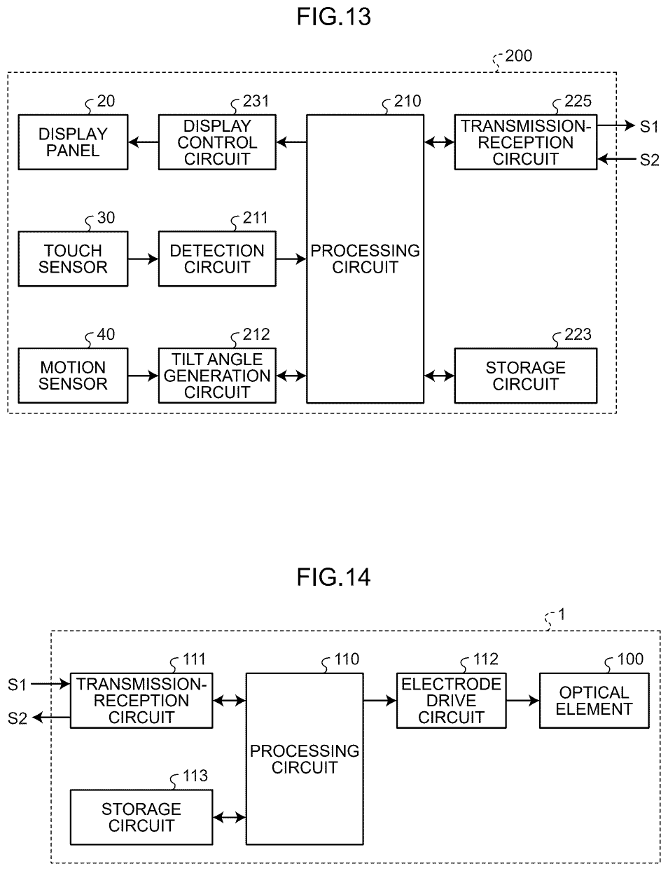

FIG. 13 is a diagram illustrating an example of a control block configuration of the control device 200 according to the first embodiment. The following describes, first, a control block configuration for executing each processing to be described later.

As illustrated in FIG. 13, the control device 200 according to the first embodiment includes the display panel 20, the touch sensor 30, the motion sensor 40, a processing circuit 210, a detection circuit 211, a tilt angle generation circuit 212, a storage circuit 223, a transmission-reception circuit 225, and a display control circuit 231. The detection circuit 211 is configured with, for example, a detection IC. Alternatively, the detection circuit 211 and the display control circuit 231 may be mounted as one display IC on the display panel 20 or on an FPC coupled to the display panel 20. The processing circuit 210, the tilt angle generation circuit 212, and the storage circuit 223 are configured with, for example, the CPU, RAM, EEPROM, and ROM of a smartphone, a tablet, or the like constituting the control device 200. The display control circuit 231 may be a display IC mounted on the display panel 20 as described above, and moreover, may include, for example, the GPU of a smartphone, a tablet, or the like constituting the control device 200. The transmission-reception circuit 225 is configured with, for example, a wireless communication module of a smartphone, a tablet, or the like constituting the control device 200.

The detection circuit 211 is a circuit that detects existence of a touch on the touch sensor 30 based on a detection signal output from each detection element 31 of the touch sensor 30.

The tilt angle generation circuit 212 is a circuit configured to acquire a tilt angle with respect to a predetermined reference plane based on a detection value output from the motion sensor 40. The tilt angle generation circuit 212 is a component provided by, for example, the CPU of a smartphone, a tablet, or the like constituting the control device 200.

The processing circuit 210 is a circuit configured to convert the tilt angle acquired by the tilt angle generation circuit 212 into a diffusion degree setting value of the illumination device 1. In addition, the processing circuit 210 detects a touch on an object (pictorial image), such as an illumination control start switch or an illumination control end switch on an illumination control application screen, based on a touch detection position detected by the detection circuit 211 and executes operation control of the illumination control application, such as start or end of diffusion degree control of the illumination device 1. In the present embodiment, the processing circuit 210 also has a function to set a corresponding range (hereinafter also referred to as a “diffusion degree adjustment range”) of the tilt angle for the diffusion degree setting value (0% to 100%). The processing circuit 210 is a component provided by, for example, the CPU of a smartphone, a tablet, or the like constituting the control device 200.

The storage circuit 223 is configured with, for example, the RAM, EEPROM, and ROM of a smartphone, a tablet, or the like constituting the control device 200. The storage circuit 223 stores an effective range of the tilt angle in diffusion degree control of the illumination device 1. In the present disclosure, the effective range of the tilt angle is defined as a range of the tilt angle, with respect to the predetermined reference plane, in which diffusion degree control of the illumination device 1 is started. When the tilt angle acquired during execution of diffusion degree control falls outside the effective range, the processing circuit 210 applies the upper or lower limit value of the effective range and converts it into the diffusion degree setting value. In the present embodiment, the diffusion degree adjustment range set by the processing circuit 210 is stored in the storage circuit 223. In addition, in the present embodiment, a diffusion degree initial value used in diffusion degree control of the illumination device 1 is stored in the storage circuit 223.

The transmission-reception circuit 225 transmits and receives setting information to and from the illumination device 1. Specifically, the transmission-reception circuit 225 receives second setting information (diffusion degree S2) transmitted from the illumination device 1 during initial setting processing in diffusion degree control of the illumination device 1 to be described later. In addition, the transmission-reception circuit 225 transmits the diffusion degree setting value, which is set during diffusion degree control processing to be described later, to the illumination device 1 as first setting information (diffusion degree S1).

The display control circuit 231 executes display control processing for displaying the illumination control application screen on the display panel 20. In the present disclosure, the display control circuit 231 performs display control of the display panel 20 based on the diffusion degree initial value of the illumination device 1, which is stored in the storage circuit 223, and the diffusion degree setting value, which is set during the diffusion degree control processing.

FIG. 14 is a diagram illustrating an example of a control block configuration of the illumination device 1 according to the first embodiment. As illustrated in FIG. 14, the illumination device 1 according to the first embodiment includes a processing circuit 110, a transmission-reception circuit 111, an electrode drive circuit 112, and a storage circuit 113 as control blocks for controlling the optical element 100 described above. The processing circuit 110 is configured with, for example, a microcomputer. The storage circuit 113 is configured with, for example, a RAM, an EEPROM, or a ROM.

The transmission-reception circuit 111 transmits and receives the setting information to and from the control device 200. Specifically, the transmission-reception circuit 111 receives the first setting information (diffusion degree S1) transmitted from the control device 200. The processing circuit 110 stores, in the storage circuit 113, the first setting information (diffusion degree S1) received by the transmission-reception circuit 111 as the diffusion degree S2. In addition, the processing circuit 110 reads the diffusion degree S2 stored in the storage circuit 113, and the transmission-reception circuit 111 transmits the diffusion degree S2 read from the storage circuit 113 by the processing circuit 110, to the control device 200 as the second setting information.

The processing circuit 110 reads the diffusion degree S2 stored in the storage circuit 113, and the electrode drive circuit 112 supplies drive voltage corresponding to the diffusion degree S2 read by the processing circuit 110 to the drive electrodes 10 and 13 of each liquid crystal cell 2 of the optical element 100.

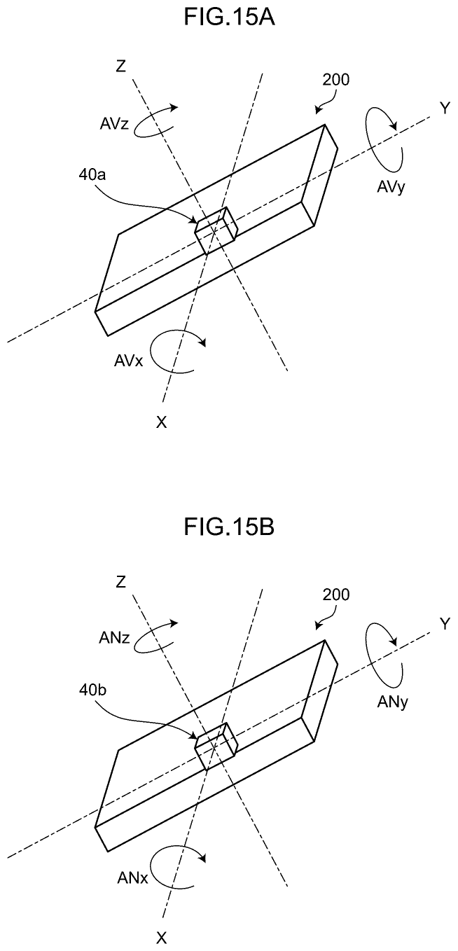

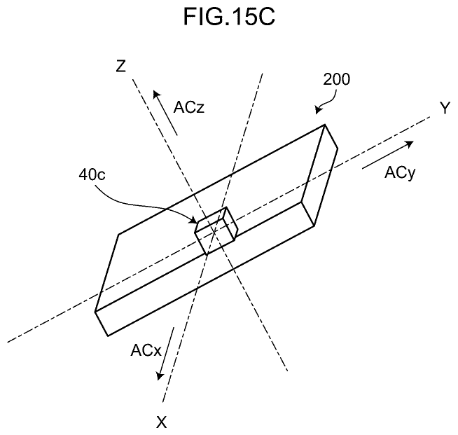

The following describes a specific example of the motion sensor 40 mounted on the control device 200 according to the first embodiment. Examples of the motion sensor 40 include a gyro sensor 40a, a geomagnetic sensor 40b, and an acceleration sensor 40c. FIG. 15A is a conceptual diagram illustrating the gyro sensor 40a as an example of the motion sensor 40 mounted on the control device 200 according to the first embodiment. FIG. 15B is a conceptual diagram illustrating the geomagnetic sensor 40b as an example of the motion sensor 40 mounted on the control device 200 according to the first embodiment. FIG. 15C is a conceptual diagram illustrating the acceleration sensor 40c as an example of the motion sensor 40 mounted on the control device 200 according to the first embodiment.

As illustrated in FIG. 15A, the gyro sensor 40a is, for example, a three-axis gyro sensor configured to sense angular velocities (AVx, AVy, and AVz) in directions along three axes of an X axis, a Y axis, and a Z axis.

As illustrated in FIG. 15B, the geomagnetic sensor 40b is, for example, a three-axis geomagnetic sensor configured to sense angles (ANx, ANy, and ANz) in directions along three axes of an X axis, a Y axis, and a Z axis with respect to a geomagnetic vector.

As illustrated in FIG. 15C, the acceleration sensor 40c is, for example, a three-axis acceleration sensor configured to sense accelerations (ACx, ACy, and ACz) in directions along three axes of an X axis, a Y axis, and a Z axis. Since a sensed value of the acceleration sensor 40c includes gravitational acceleration, a horizontal direction and a vertical direction can be defined with respect to the gravitational acceleration.

In the present disclosure, the tilt angle generation circuit 212 of the control device 200 acquires a tilt angle representing tilt of the control device 200 with respect to the predetermined reference plane by using a detection value of at least one of the gyro sensor 40a, the geomagnetic sensor 40b, and the acceleration sensor 40c. Alternatively, more than one of the gyro sensor 40a, the geomagnetic sensor 40b, and the acceleration sensor 40c may be combined to acquire the tilt angle. The motion sensors 40 used for acquisition of the tilt angle are not limited to the gyro sensor 40a, the geomagnetic sensor 40b, and the acceleration sensor 40c. Moreover, the present disclosure is not limited by combination of the motion sensors 40 used for acquisition of the tilt angle.

The following describes specific examples of processing and display aspects of the illumination control application that operates in the control device 200 according to the first embodiment in detail. In description of the present disclosure, it is assumed that the illumination control application is installed on the control device 200 in advance.

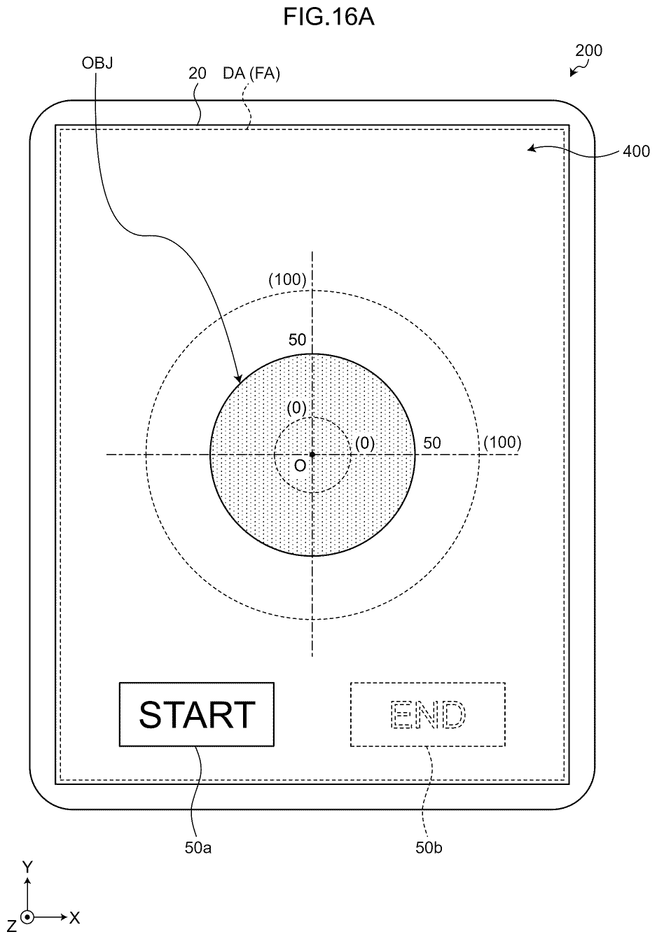

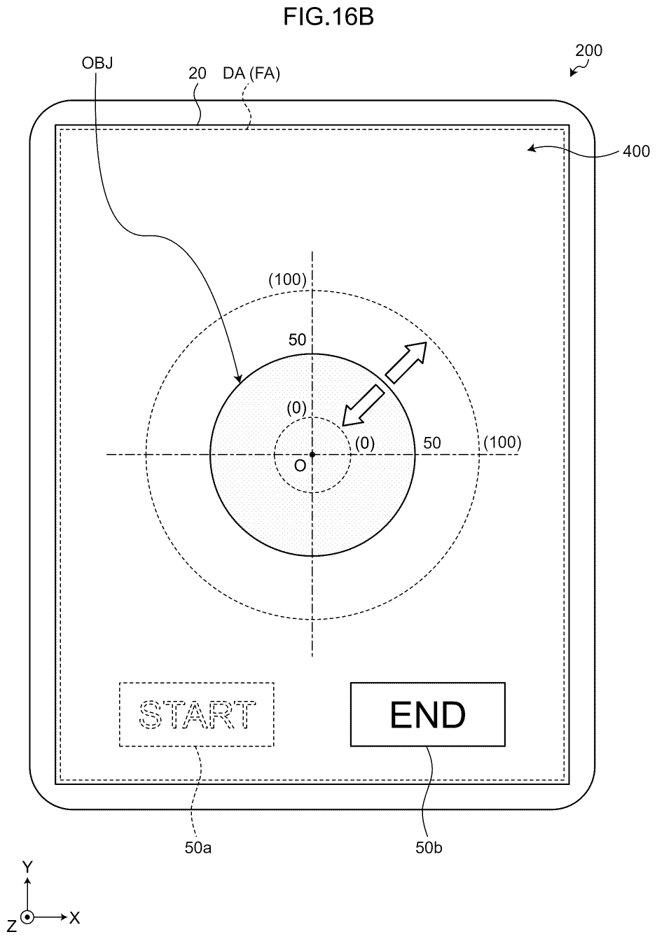

FIG. 16A is a conceptual diagram illustrating a first example of the display aspect of an illumination control application screen 400 on the control device 200 according to the first embodiment. FIG. 16B is a conceptual diagram illustrating a second example of the display aspect of the illumination control application screen 400 on the control device 200 according to the first embodiment.

When the illumination control application is activated, the illumination control application screen 400 illustrated in FIG. 16A is displayed and pairing processing is executed between the control device 200 and the illumination device 1. A pairing button (not illustrated) may be displayed on the illumination control application screen 400, and pairing processing may be executed between the control device 200 and the illumination device 1 when the pairing button is touched by a user.

A diffusion degree control start switch 50a for selecting start of the diffusion degree control processing and a diffusion degree control end switch 50b for selecting end of the diffusion degree control processing are provided on the illumination control application screen 400. In the present disclosure, after activation of the illumination control application, before execution of the diffusion degree control processing, the diffusion degree control start switch 50a is enabled (selectable), and the diffusion degree control end switch 50b is grayed out and disabled (not selectable) (refer to FIG. 16A). When the diffusion degree control start switch 50a is selected to start the diffusion degree control processing, the diffusion degree control start switch 50a is grayed out and disabled (not selectable) and the diffusion degree control end switch 50b is enabled (selectable) (refer to FIG. 16B). The configuration is not limited to the aspect in which the diffusion degree control start switch 50a and the diffusion degree control end switch 50b are separately provided, and may be, for example, an aspect in which start and end of the diffusion degree control processing can be selected through toggle operation of one switch.

On the illumination control application screen 400 illustrated in FIGS. 16A and 16B, the X direction is defined as the Dx direction (first direction) in diffusion degree control of the illumination device 1, and the Y direction is defined as the Dy direction (second direction) in diffusion degree control of the illumination device 1. An XY plane with an origin O at a predetermined position in a display region DA is defined on the illumination control application screen 400. A direction orthogonal to the XY plane is defined as the Z direction.

The display panel 20 is provided with the display region DA overlapping the detection region FA of the touch sensor 30 in plan view. In the example illustrated in FIGS. 16A and 16B, a light distribution shape object OBJ having a center point at the origin O of the XY plane on the illumination control application screen 400 is displayed.

The light distribution shape object OBJ is a pictorial image on the illumination control application screen 400, corresponding to the light distribution state of light emitted from the illumination device 1.

In the configuration according to the first embodiment, the size of the light distribution shape object OBJ on the illumination control application screen 400 changes with the diffusion degree of the illumination device 1.

As illustrated in FIG. 9, in the illumination device 1 as a control target in the present disclosure, a predetermined substantially circular area corresponding to outline “d” is irradiated with light even in a case where the diffusion degree (both the horizontal and vertical diffusion degrees) of the illumination device 1 is 0%. In the present disclosure, the light distribution shape object OBJ in a small circular shape overlapping the inner dashed line illustrated in FIGS. 16A and 16B is displayed in a case where the horizontal and vertical diffusion degrees are both 0%. The light distribution shape object OBJ in a large circular shape overlapping the outer dashed line illustrated in FIGS. 16A and 16B, which corresponds to outline “a” in FIG. 9, is displayed in a case where the horizontal and vertical diffusion degrees of the illumination device 1 are both 100%.

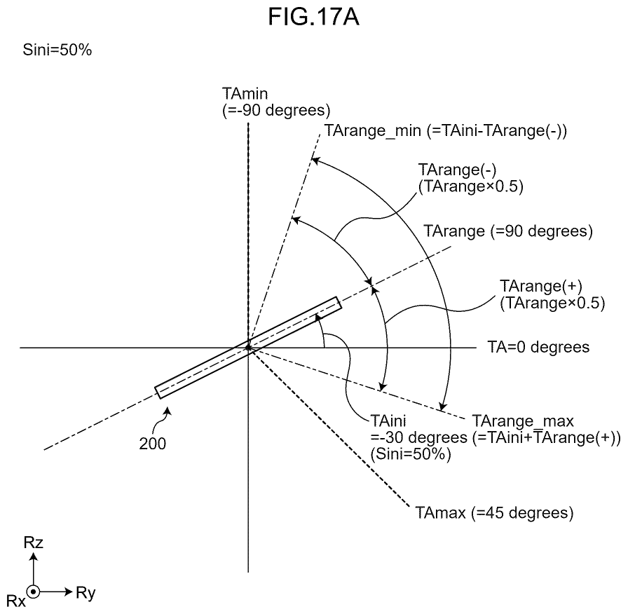

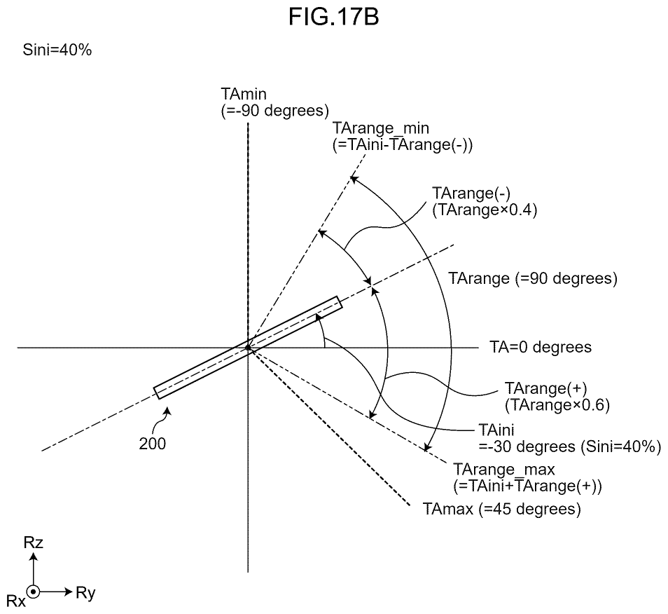

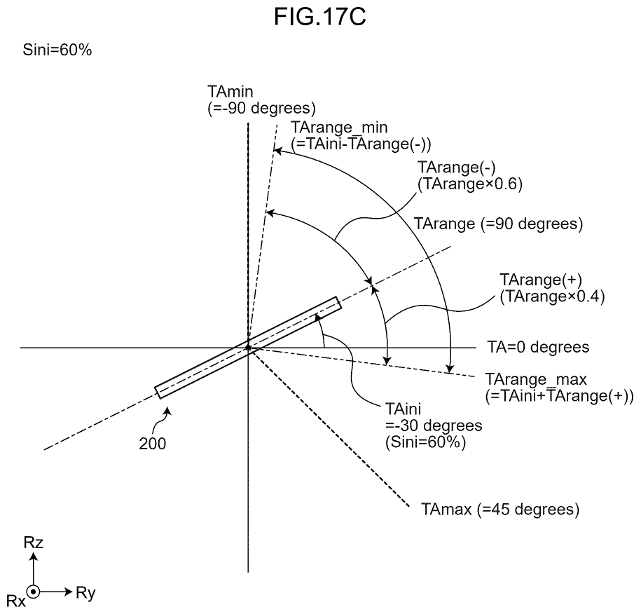

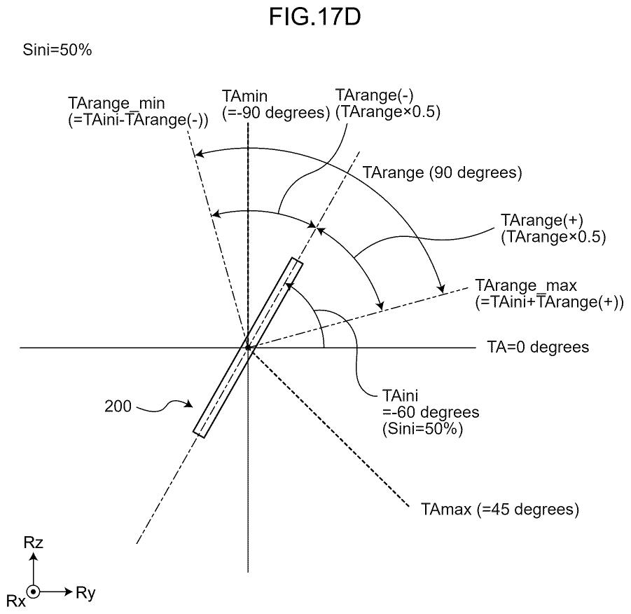

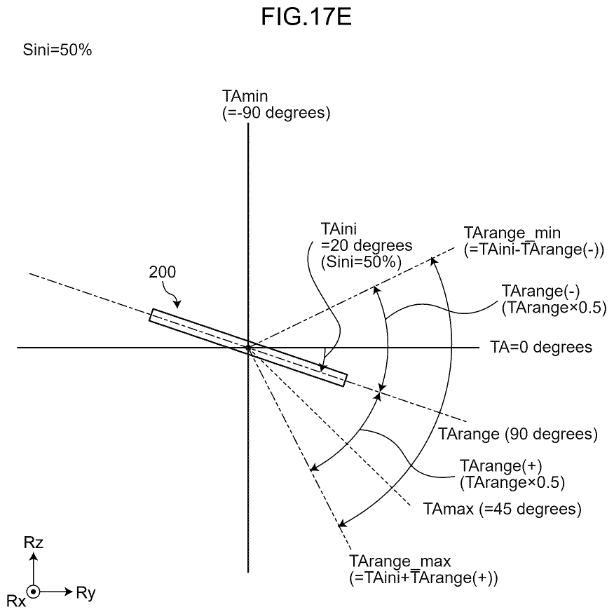

FIG. 17A is a first diagram illustrating the relation between the effective range of the tilt angle and the diffusion degree adjustment range in diffusion degree control according to the first embodiment. FIG. 17B is a second diagram illustrating the relation between the effective range of the tilt angle and the diffusion degree adjustment range in diffusion degree control according to the first embodiment. FIG. 17C is a third diagram illustrating the relation between the effective range of the tilt angle and the diffusion degree adjustment range in diffusion degree control according to the first embodiment. FIG. 17D is a fourth diagram illustrating the relation between the effective range of the tilt angle and the diffusion degree adjustment range in diffusion degree control according to the first embodiment. FIG. 17E is a fifth diagram illustrating the relation between the effective range of the tilt angle and the diffusion degree adjustment range in diffusion degree control according to the first embodiment.

In FIGS. 17A, 17B, 17C, 17D, and 17E, an Rx direction corresponding to the X direction on the illumination control application screen 400 of the control device 200 (the Dx direction (first direction) in diffusion degree control of the illumination device 1), an Ry direction corresponding to the Y direction on the illumination control application screen 400 of the control device 200 (the Dy direction (second direction) in diffusion degree control of the illumination device 1), and an Rz direction orthogonal to a RxRy plane as a reference plane, are defined in an RyRz plan view of the control device 200 when diffusion degree control according to the first embodiment is executed.

In addition, a tilt angle TA is defined as the tilt of the XY plane in the Y direction with respect to a reference plane where the tilt of the control device 200 (XY plane on the illumination control application screen 400) in the Y direction with respect to the RxRy plane is 0 degrees. In the present disclosure, the reference plane is, for example, a horizontal plane acquired from the detection value of the motion sensor 40 (the gyro sensor 40a, the geomagnetic sensor 40b, or the acceleration sensor 40c).

In the present disclosure, an upper limit value TAmax and a lower limit value TAmin of the effective range of the tilt angle TA in diffusion degree control of the illumination device 1 are set as illustrated in FIGS. 17A, 17B, 17C, 17D, and 17E. In the example illustrated in FIGS. 17A, 17B, 17C, 17D, and 17E, the upper limit value TAmax and the lower limit value TAmin of the effective range of the tilt angle TA, are 45 degrees and −90 degrees, respectively. The effective range of the tilt angle TA in diffusion degree control of the illumination device 1 may be set to a range in which the user can tilt the control device 200 held in hand without difficulty.

In the present disclosure, a diffusion degree adjustment range TArange that is a corresponding range of the tilt angle TA for the diffusion degree setting value (0% to 100%) is set as illustrated in FIGS. 17A, 17B, 17C, 17D, and 17E.

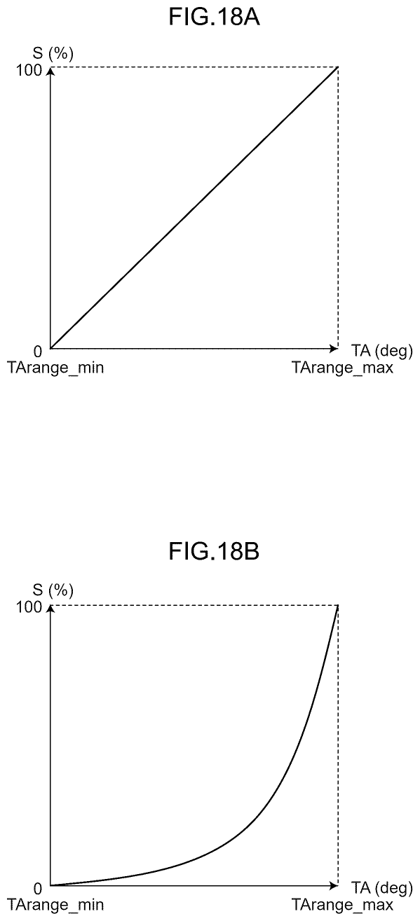

FIG. 18A is a line diagram illustrating a first example of tilt angle-to-diffusion degree setting value conversion characteristics in diffusion degree control according to the first embodiment. In the first embodiment, a diffusion degree setting value S has a characteristic of increasing as the tilt angle TA increases as illustrated in FIG. 18A. A range from a lower limit value TArange_min of the diffusion degree adjustment range TArange to an upper limit value TArange_max thereof is, for example, 90 degrees.

In the first embodiment, the diffusion degree adjustment range TArange is set by diffusion degree adjustment range setting processing to be described later. Specifically, the diffusion degree of the illumination device 1 before diffusion degree control is started is set as a diffusion degree initial value Sini, the tilt angle when diffusion degree control of the illumination device 1 is started is set as a tilt angle initial value TAini, and the diffusion degree initial value Sini and the tilt angle initial value TAini are associated. In other words, the diffusion degree setting value S is set to Sini when the tilt angle TA is TAini.

For example, a value TArange (+) (TArange×0.6 in the example of Sini=40% illustrated in FIG. 17B) obtained by multiplying the diffusion degree adjustment range TArange (for example, 90 degrees) by (1−Sini/100) is added to the tilt angle initial value TAini, thereby obtaining the upper limit value TArange_max (=TAini+TArange (+)) of the diffusion degree adjustment range TArange. In addition, a value TArange (−) (TArange×0.4 in the example of Sini=40% illustrated in FIG. 17B) obtained by multiplying the diffusion degree adjustment range TArange (for example, 90 degrees) by Sini/100 is subtracted from the tilt angle initial value TAini, thereby obtaining the lower limit value TArange_min (=TAini−TArange (−)) of the diffusion degree adjustment range TArange. Accordingly, the diffusion degree adjustment range TArange is set. Alternatively, after the upper limit value TArange_max of the diffusion degree adjustment range TArange is calculated, the magnitude of the diffusion degree adjustment range TArange may be subtracted from the upper limit value TArange_max of the diffusion degree adjustment range TArange to derive the lower limit value TArange_min; and after the lower limit value TArange_min of the diffusion degree adjustment range TArange is calculated, the magnitude of the diffusion degree adjustment range TArange may be added to the lower limit value TArange_min of the diffusion degree adjustment range TArange to derive the upper limit value TArange_max.

In the first example of tilt angle-to-diffusion degree setting value conversion characteristics, which is illustrated in FIG. 18A, the diffusion degree setting value S linearly changes with a change of the tilt angle TA within the range from the lower limit value TArange_min to the upper limit value TArange_max of the diffusion degree adjustment range TArange.

FIG. 17A illustrates an example with the diffusion degree initial value Sini=50% and the tilt angle initial value TAini=−30 degrees.

FIG. 17B illustrates an example with the diffusion degree initial value Sini=40% and the tilt angle initial value TAini=−30 degrees.

FIG. 17C illustrates an example with the diffusion degree initial value Sini=60% and the tilt angle initial value TAini=−30 degrees.

FIG. 17D illustrates an example with the diffusion degree initial value Sini=50% and the tilt angle initial value TAini=−60 degrees.

FIG. 17E illustrates an example with the diffusion degree initial value Sini=50% and the tilt angle initial value TAini=20 degrees.

In the first embodiment, the diffusion degree setting value S is set to a maximum value (Smax=100%) when the upper limit value TArange_max of the diffusion degree adjustment range TArange is smaller than the upper limit value TAmax of the effective range of the tilt angle TA (FIGS. 17A, 17B, 17C, and 17D) and the tilt angle TA is equal to or larger than the upper limit value TArange_max of the diffusion degree adjustment range TArange.

The upper limit value TAmax of the effective range of the tilt angle TA is converted into the diffusion degree setting value S when the upper limit value TArange_max of the diffusion degree adjustment range TArange is equal to or larger than the upper limit value TAmax of the effective range of the tilt angle TA (FIG. 17E) and the tilt angle TA is equal to or larger than the upper limit value TAmax of the effective range of the tilt angle TA.

The diffusion degree setting value S is set to a minimum value (Smax=0%) when the lower limit value TArange_min of the diffusion degree adjustment range TArange is larger than the lower limit value TAmin of the effective range of the tilt angle TA (FIGS. 17A, 17B, 17C, and 17E) and the tilt angle TA is equal to or smaller than the lower limit value TArange_min of the diffusion degree adjustment range TArange.

The lower limit value TAmin of the effective range of the tilt angle TA is converted into the diffusion degree setting value S when the lower limit value TArange_min of the diffusion degree adjustment range TArange is equal to or smaller than the lower limit value TAmin of the effective range of the tilt angle TA (FIG. 17D) and the tilt angle TA is equal to or smaller than the lower limit value TAmin of the effective range of the tilt angle TA.

Change of the diffusion degree setting value S with change in the tilt angle TA is not limited to linear change. FIG. 18B is a line diagram illustrating a second example of tilt angle-to-diffusion degree setting value conversion characteristics in diffusion degree control according to the first embodiment. In the second example of tilt angle-to-diffusion degree setting value conversion characteristics, which is illustrated in FIG. 18B, the change rate of the diffusion degree setting value S increases as the tilt angle TA increases.

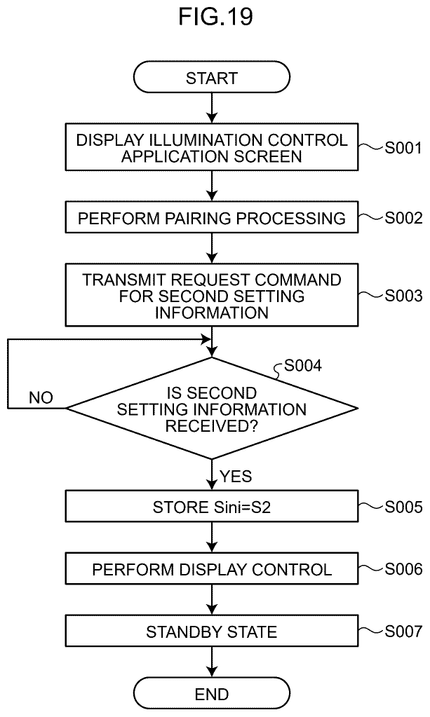

The following describes specific examples of processing by the control device 200 for the illumination device 1 according to the first embodiment described above. FIG. 19 is a flowchart illustrating an example of the initial setting processing in diffusion degree control according to the first embodiment.

When the illumination control application is activated on the control device 200, the illumination control application screen 400 illustrated in FIG. 16A is displayed on the display region DA (step S001).

The transmission-reception circuit 225 of the control device 200 executes pairing processing with the illumination device 1 (step S002) and transmits a request command for the second setting information to the illumination device 1 (step S003).

The processing circuit 110 of the illumination device 1 reads the diffusion degree S2 stored in the storage circuit 113, and the transmission-reception circuit 111 of the illumination device 1 transmits the diffusion degree S2 read by the processing circuit 110 to the control device 200 as the second setting information. The electrode drive circuit 112 of the illumination device 1 supplies drive voltage corresponding to the diffusion degree S2 read by the processing circuit 110 to the drive electrodes 10 and 13 of each liquid crystal cell 2 of the optical element 100.

The transmission-reception circuit 225 of the control device 200 determines whether the second setting information is received from the illumination device 1 (step S004). If the second setting information is not received from the illumination device 1 (No at step S004), the processing at step S004 is re-executed.

When the transmission-reception circuit 225 receives the second setting information from the illumination device 1 (Yes at step S004), the processing circuit 110 stores the second setting information (diffusion degree S2) received from the illumination device 1 in the storage circuit 223 as the diffusion degree initial value Sini (Sini=S2) (step S005), and the display control circuit 231 of the control device 200 reflects the diffusion degree initial value Sini to display control on the illumination control application screen 400 (step S006).

When the processing up to step S006 ends, the process transitions to a standby state (step S007), thereby ending the initial setting processing.

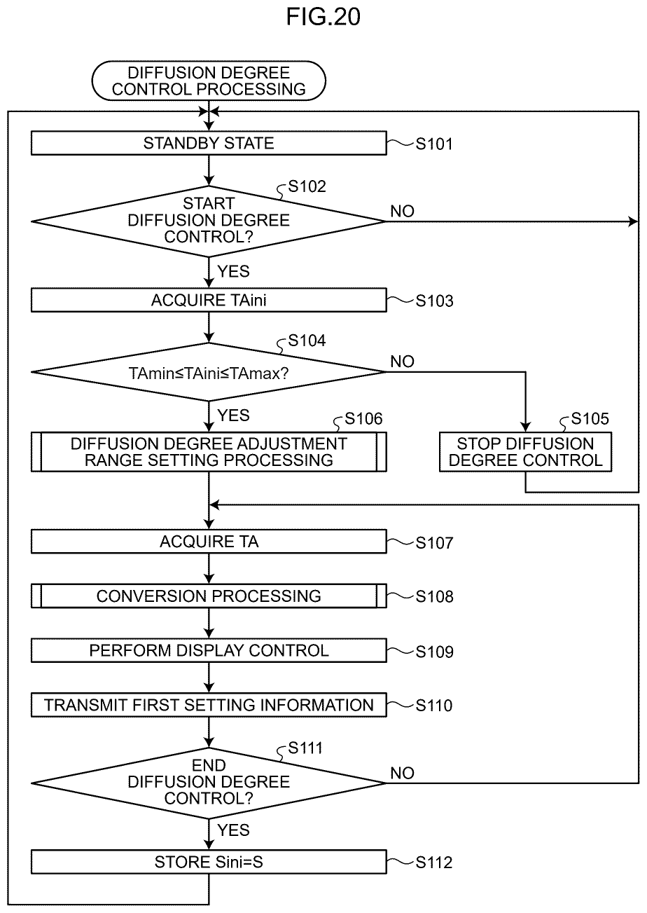

After the initial setting processing illustrated in FIG. 19 is ended, the process transitions to the diffusion degree control processing illustrated in FIG. 20. FIG. 20 is a flowchart illustrating an example of an overall sequence of the diffusion degree control processing according to the first embodiment.

In a standby state after the end of the initial setting processing and the transition to the diffusion degree control processing illustrated in FIG. 20 (step S101), the control device 200 executes touch detection processing for the diffusion degree control start switch 50a and determines whether diffusion degree control can be started (step S102).

Specifically, when no touch on the diffusion degree control start switch 50a is detected, the processing circuit 210 does not start diffusion degree control (No at step S102) and returns to the standby state at step S101 to re-execute processing at steps S101 and S102.

When a touch on the diffusion degree control start switch 50a is detected, the processing circuit 210 starts diffusion degree control (Yes at step S102) and transitions to processing at step S103.

When diffusion degree control is started (Yes at step S102), the tilt angle generation circuit 212 acquires the tilt angle initial value TAini (step S103). The processing circuit 210 determines whether the tilt angle initial value TAini acquired by the tilt angle generation circuit 212 is within the effective range (TAmin≤TAini≤TAmax) (step S104). When the tilt angle initial value TAini is outside the effective range (No at step S104), in other words, when the tilt angle initial value TAini is smaller than the lower limit value TAmin of the effective range (TAini<TAmin) or is larger than the upper limit value TAmax of the effective range (TAini>TAmax), the processing circuit 210 stops diffusion degree control (step S105) and re-executes processing at steps S101 to S104. At this time, the control device 200 may display, on a display screen, an image informing the user that the diffusion degree control processing is disabled in the current angle state.

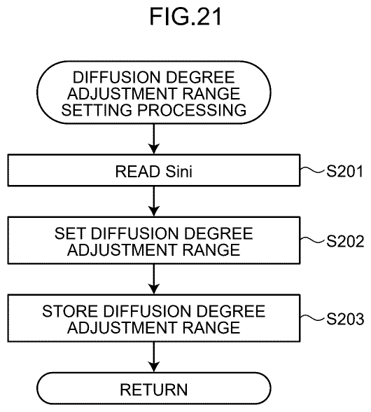

When the tilt angle initial value TAini is within the effective range (Yes at step S104), in other words, when the tilt angle initial value TAini is equal to or larger than the lower limit value TAmin of the effective range and is equal to or smaller than the upper limit value TAmax of the effective range (TAmin≤TAini≤TAmax), the process transitions to the diffusion degree adjustment range setting processing illustrated in FIG. 21 (step S106). FIG. 21 is a flowchart illustrating an example of the diffusion degree adjustment range setting processing in diffusion degree control according to the first embodiment.

After the transition to the diffusion degree adjustment range setting processing illustrated in FIG. 21, the processing circuit 210 reads the diffusion degree initial value Sini stored in the storage circuit 223 (step S201), sets the diffusion degree adjustment range TArange (step S202), and stores the set diffusion degree adjustment range TArange in the storage circuit 223 (step S203).

Specifically, for example, the processing circuit 210 adds the value TArange (+), which is obtained by multiplying the diffusion degree adjustment range TArange (for example, 90 degrees) by (1−Sini/100), to the tilt angle initial value TAini, thereby setting the upper limit value TArange_max of the diffusion degree adjustment range TArange (=TAini+TArange (+)). In addition, the processing circuit 210 subtracts the value TArange (−), which is obtained by multiplying the diffusion degree adjustment range TArange (for example, 90 degrees) by Sini/100, from the tilt angle initial value TAini, thereby setting the lower limit value TArange_min of the diffusion degree adjustment range TArange (=TAini−TArange (−)). Then, a tilt angle-to-diffusion degree setting value conversion characteristic is generated that the diffusion degree setting value S linearly changes with a change of the tilt angle TA as illustrated in FIG. 18A.

The processing circuit 210 may generate, in place of the tilt angle-to-diffusion degree setting value conversion characteristic illustrated in FIG. 18A, a tilt angle-to-diffusion degree setting value conversion characteristic that the change rate of the diffusion degree setting value S increases as the tilt angle TA increases as illustrated in FIG. 18B. In a region where the diffusion degree setting value S is relatively small, the entire irradiation surface is easily visually recognizable. Moreover, the irradiation surface is brighter and the outline of the irradiation area is clearer than in a case where the diffusion degree is relatively large due to a narrowed irradiation angle, and thus change of the irradiation area of light with respect to change of the tilt angle TA is more easily recognizable than in a region where the diffusion degree setting value S is relatively large. By generating the tilt angle-to-diffusion degree setting value conversion characteristic that the change rate of the diffusion degree setting value S increases as the tilt angle TA increases as illustrated in FIG. 18B, it is possible to make change of the irradiation area of light with respect to change of the tilt angle TA more gentle in a region where the diffusion degree setting value S is relatively small than in a region where the diffusion degree setting value S is relatively large, thereby facilitating fine adjustment.

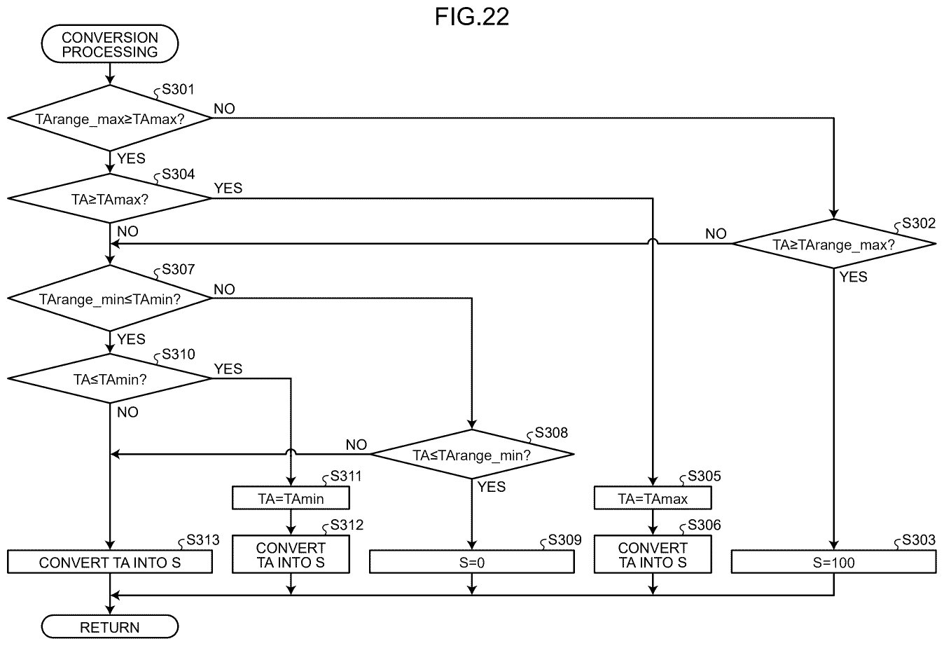

Referring back to FIG. 20, the tilt angle generation circuit 212 acquires the tilt angle TA (step S107), and the processing circuit 210 transitions to tilt angle-to-diffusion degree conversion processing illustrated in FIG. 22 (step S108). FIG. 22 is a flowchart illustrating an example of the tilt angle-to-diffusion degree conversion processing in diffusion degree control according to the first embodiment.

In the tilt angle-to-diffusion degree conversion processing illustrated in FIG. 22, first, the processing circuit 210 determines whether the upper limit value TArange_max of the diffusion degree adjustment range TArange is equal to or larger than the upper limit value TAmax of the effective range of the tilt angle TA (TArange_max≥TAmax) (step S301).

When the upper limit value TArange_max of the diffusion degree adjustment range TArange is smaller than the upper limit value TAmax of the effective range of the tilt angle TA (TArange_max<TAmax; No at step S301), the processing circuit 210 subsequently determines whether the tilt angle TA acquired by the tilt angle generation circuit 212 is equal to or larger than the upper limit value TArange_max of the diffusion degree adjustment range TArange (TA≥TArange_max) (step S302).

When the tilt angle TA is equal to or larger than the upper limit value TArange_max of the diffusion degree adjustment range TArange (TA≥TArange_max; Yes at step S302), the processing circuit 210 sets the diffusion degree setting value S to the maximum value (Smax=100%) (step S303) and returns to the diffusion degree control processing illustrated in FIG. 20.

When the upper limit value TArange_max of the diffusion degree adjustment range TArange is equal to or larger than the upper limit value TAmax of the effective range of the tilt angle TA (TArange_max≥TAmax; Yes at step S301), the processing circuit 210 subsequently determines whether the tilt angle TA is equal to or larger than the upper limit value TAmax of the effective range of the tilt angle TA (TA≥TAmax) (step S304).

When the tilt angle TA is equal to or larger than the upper limit value TAmax of the effective range of the tilt angle TA (TA≥TAmax; Yes at step S304), the processing circuit 210 sets the tilt angle TA to the upper limit value TAmax of the effective range of the tilt angle TA (TA=TAmax; step S305), converts the tilt angle TA into the diffusion degree setting value S (step S306), and returns to the diffusion degree control processing illustrated in FIG. 20.

When the tilt angle TA is smaller than the upper limit value TArange_max of the diffusion degree adjustment range TArange (TA<TArange_max; No at step S302) and when the tilt angle TA is smaller than the upper limit value TAmax of the effective range of the tilt angle TA (TA<TAmax; No at step S304), the processing circuit 210 subsequently determines whether the lower limit value TArange_min of the diffusion degree adjustment range TArange is equal to or smaller than the lower limit value TAmin of the effective range of the tilt angle TA (TArange_min≤TAmin) (step S307).

When the lower limit value TArange_min of the diffusion degree adjustment range TArange is larger than the lower limit value TAmin of the effective range of the tilt angle TA (TArange_min>TAmin; No at step S307), the processing circuit 210 subsequently determines whether the tilt angle TA acquired by the tilt angle generation circuit 212 is equal to or smaller than the lower limit value TArange_min of the diffusion degree adjustment range TArange (TA≤TArange_min) (step S308).

When the tilt angle TA is equal to or smaller than the lower limit value TArange_min of the diffusion degree adjustment range TArange (TA≤TArange_min; Yes at step S308), the processing circuit 210 sets the diffusion degree setting value S to the minimum value (Smin=0%) (step S309) and returns to the diffusion degree control processing illustrated in FIG. 20.

When the lower limit value TArange_min of the diffusion degree adjustment range TArange is equal to or smaller than the lower limit value TAmin of the effective range of the tilt angle TA (TArange_min≤TAmin; Yes at step S307), the processing circuit 210 subsequently determines whether the tilt angle TA is equal to or smaller than the lower limit value TAmin of the effective range of the tilt angle TA (TA≤TAmin) (step S310).

When the tilt angle TA is equal to or smaller than the lower limit value TAmin of the effective range of the tilt angle TA (TA≤TAmin; Yes at step S310), the processing circuit 210 sets the tilt angle TA to the lower limit value TAmin of the effective range of the tilt angle TA (TA=TAmin; step S311), converts the tilt angle TA into the diffusion degree setting value S (step S312), and returns to the diffusion degree control processing illustrated in FIG. 20.

When the tilt angle TA is larger than the lower limit value TArange_min of the diffusion degree adjustment range TArange (TA>TArange_min; No at step S308) and when the tilt angle TA is larger than the lower limit value TAmin of the effective range of the tilt angle TA (TA>TAmin; No at step S310), the processing circuit 210 converts the tilt angle TA acquired by the tilt angle generation circuit 212 into the diffusion degree setting value S (step S313) and returns to the diffusion degree control processing illustrated in FIG. 20.

Referring back to FIG. 20, the display control circuit 231 reflects the diffusion degree setting value S set by the processing circuit 210 to display control on the illumination control application screen 400 (step S109). In addition, the transmission-reception circuit 225 transmits the diffusion degree setting value S set by the processing circuit 210 to the illumination device 1 as the first setting information (diffusion degree S1) (step S110).

The transmission-reception circuit 111 of the illumination device 1 stores the first setting information (diffusion degree S1) transmitted from the control device 200, in the storage circuit 113 as new diffusion degree S2. In addition, the electrode drive circuit 112 of the illumination device 1 supplies drive voltage corresponding to the diffusion degree S2 stored in the storage circuit 113 by the processing circuit 210 to the drive electrodes 10 and 13 of each liquid crystal cell 2 of the optical element 100.

The control device 200 executes touch detection processing of detecting a touch on the diffusion degree control end switch 50b and determines whether diffusion degree control can be ended (step S111).

Specifically, when no touch on the diffusion degree control end switch 50b is detected, the processing circuit 210 does not end diffusion degree control (No at step S111) and returns to processing at step S107 to repeatedly execute processing at steps S107 to S111.

In the present disclosure, a sampling rate at which processing at steps S107 to S111 is repeatedly executed is, for example, 5 Hz to 60 Hz approximately. Since a higher sampling rate enables smoother control, the sampling rate is preferably 30 Hz to 60 Hz approximately, for example.

When a touch on the diffusion degree control end switch 50b is detected, the processing circuit 210 ends diffusion degree control (Yes at step S111), stores the diffusion degree setting value S set by the tilt angle-to-diffusion degree conversion processing illustrated in FIG. 22 in the storage circuit 223 as the diffusion degree initial value Sini (step S112), and returns to the standby state at step S101.

Through diffusion degree control according to the first embodiment described above, the control device 200 sets a diffusion degree in accordance with the tilt of the control device 200. Accordingly, without operating the screen of the control device 200 held in hand, the user can stably adjust the diffusion degree of the illumination device 1 with one hand, which results in improvement of usability in diffusion degree control of the illumination device 1.

In diffusion degree control according to the first embodiment described above, the control device 200 sets the corresponding range (diffusion degree adjustment range TArange) of the tilt angle TA for the diffusion degree setting value S by associating the diffusion degree initial value Sini of the illumination device 1 before the start of the diffusion degree control with the tilt angle initial value TAini at the start of the diffusion degree control. When starting diffusion degree control again, the diffusion degree adjustment range TArange is set by using, as the diffusion degree initial value Sini, the diffusion degree at the end of the previous diffusion degree control. Accordingly, the diffusion degree of the illumination device 1 can be seamlessly adjusted before and after the start of diffusion degree control.

### Second Embodiment

In the diffusion degree adjustment range setting processing after the start of diffusion degree control in the aspect exemplarily described in the first embodiment, the diffusion degree initial value Sini of the illumination device 1 before the start of the diffusion degree control and the tilt angle initial value TAini at the start of the diffusion degree control are associated to set the diffusion degree adjustment range TArange. A second embodiment exemplarily describes an aspect in which the diffusion degree adjustment range TArange is set within the effective range of the tilt angle TA in advance.

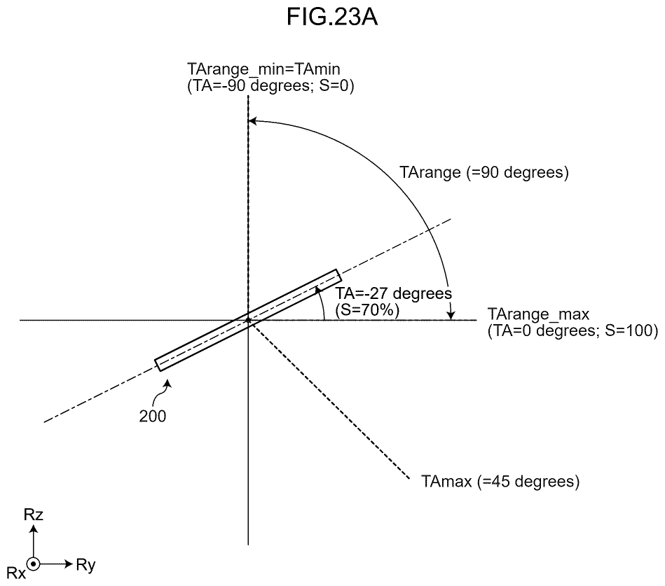

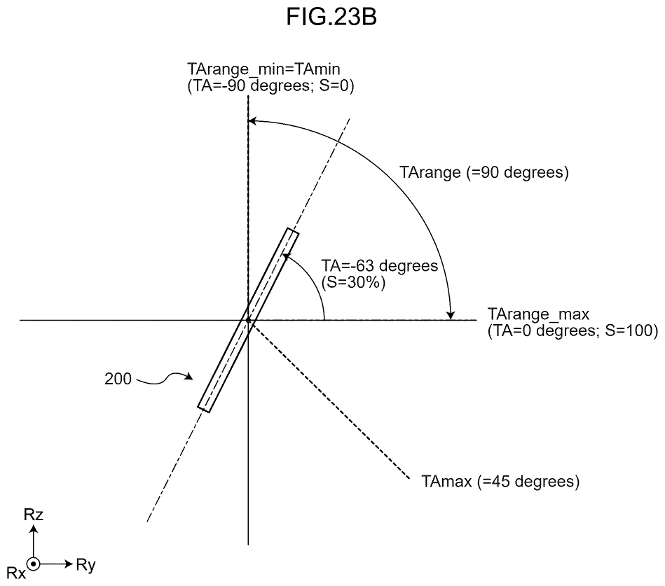

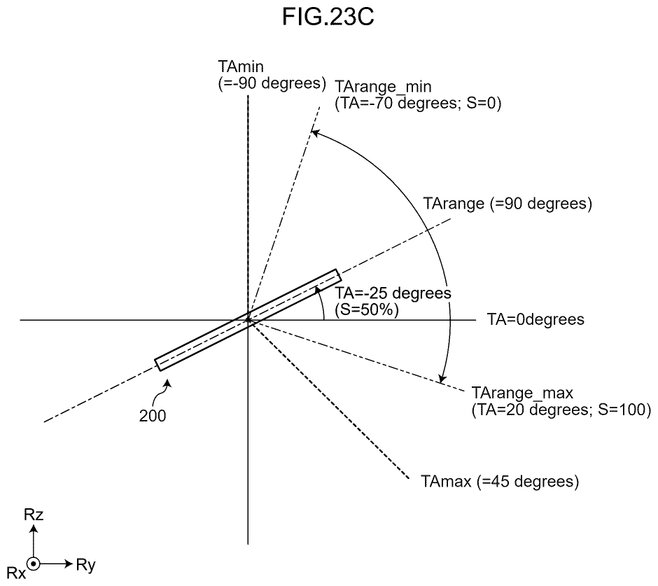

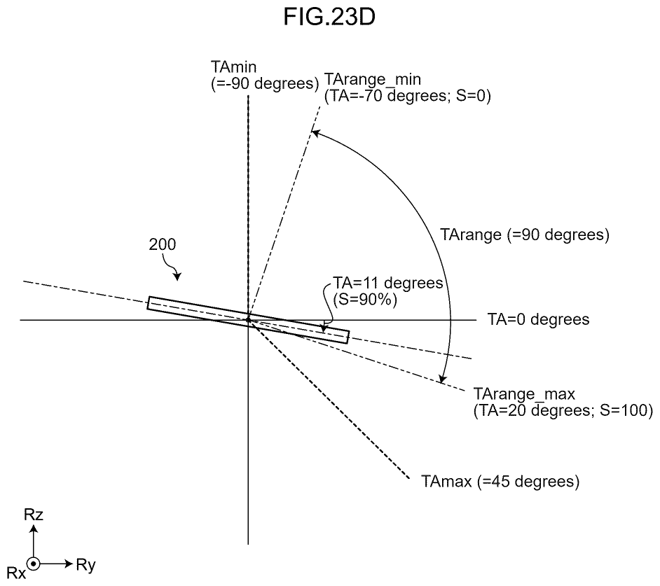

FIG. 23A is a first diagram illustrating the relation between the effective range of the tilt angle and the diffusion degree adjustment range in diffusion degree control according to the second embodiment. FIG. 23B is a second diagram illustrating the relation between the effective range of the tilt angle and the diffusion degree adjustment range in diffusion degree control according to the second embodiment. FIG. 23C is a third diagram illustrating the relation between the effective range of the tilt angle and the diffusion degree adjustment range in diffusion degree control according to the second embodiment. FIG. 23D is a fourth diagram illustrating the relation between the effective range of the tilt angle and the diffusion degree adjustment range in diffusion degree control according to the second embodiment.

Although FIGS. 23A, 23A, 23C, and 23D exemplarily illustrate the aspect (FIG. 18A) in which the diffusion degree setting value S linearly changes with a change of the tilt angle TA, the present embodiment is also applicable to the aspect (FIG. 18B) in which the change rate of the diffusion degree setting value S increases as the tilt angle TA increases.

FIGS. 23A and 23B illustrate an example with the upper limit value TArange_max=0 degrees and the lower limit value TArange_min=−90 degrees of the diffusion degree adjustment range TArange. In this case, for example, the diffusion degree setting value S=70% corresponds to the tilt angle TA=−27 degrees (FIG. 23A), and the diffusion degree setting value S=30% corresponds to the tilt angle TA=−63 degrees (FIG. 23B).

FIGS. 23C and 23D illustrate an example with the upper limit value TArange_max=20 degrees and the lower limit value TArange_min=−70 degrees of the diffusion degree adjustment range TArange. In this case, for example, the diffusion degree setting value S=50% corresponds to the tilt angle TA=−25 degrees (FIG. 23C), and the diffusion degree setting value S=90% corresponds to the tilt angle TA=11 degrees (FIG. 23D).

In the second embodiment, the diffusion degree setting value S is set to the maximum value (Smax=100%) in a case where the tilt angle TA is equal to or larger than the upper limit value TArange_max of the diffusion degree adjustment range TArange.

The diffusion degree setting value S is set to the minimum value (Smax=0%) in a case where the tilt angle TA is equal to or smaller than the lower limit value TArange_min of the diffusion degree adjustment range TArange.

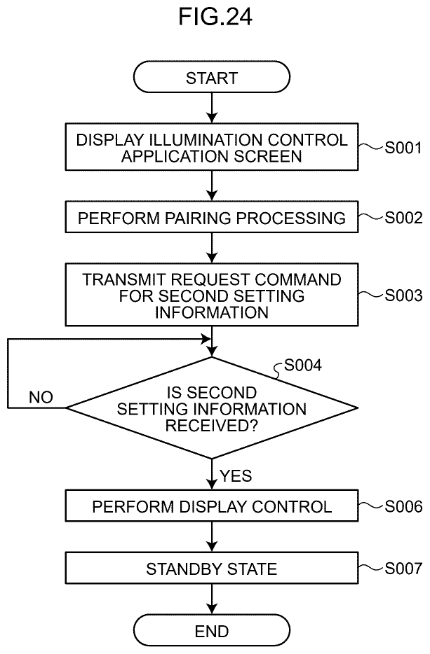

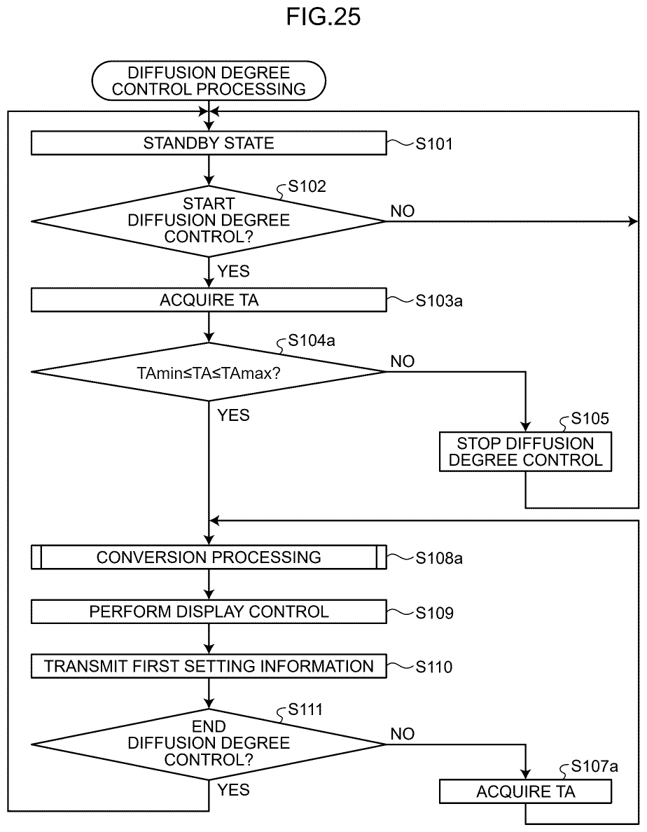

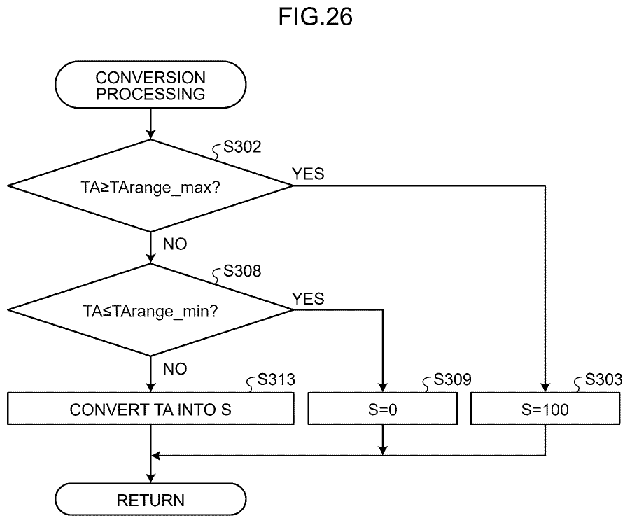

The following describes specific examples of processing by the control device 200 for the illumination device 1 according to the second embodiment described above. FIG. 24 is a flowchart illustrating an example of the initial setting processing in diffusion degree control according to the second embodiment. FIG. 25 is a flowchart illustrating an example of an overall sequence of the diffusion degree control processing according to the second embodiment. FIG. 26 is a flowchart illustrating an example of the tilt angle-to-diffusion degree conversion processing in diffusion degree control according to the second embodiment. The following description will be made on processing different from that in the first embodiment, and duplicate description is omitted in some cases.

In the second embodiment, the diffusion degree adjustment range TArange is set within the effective range of the tilt angle TA in advance as described above. Thus, in the initial setting processing illustrated in FIG. 24, processing (FIG. 19; step S005) of storing the second setting information (diffusion degree S2) received from the illumination device 1 in the storage circuit 223 as the diffusion degree initial value Sini is omitted; furthermore, in the diffusion degree control processing illustrated in FIG. 25, processing (FIG. 20; step S112) of storing the diffusion degree setting value S set by the tilt angle-to-diffusion degree conversion processing illustrated in FIG. 26 in the storage circuit 223 as the diffusion degree initial value Sini is omitted.

When the process transitions to the diffusion degree control processing illustrated in FIG. 25 and diffusion degree control is started (Yes at step S102), the tilt angle generation circuit 212 acquires the tilt angle TA (step S103a). The processing circuit 210 determines whether the tilt angle TA acquired by the tilt angle generation circuit 212 is within the effective range (TAmin≤TA≤TAmax) (step S104a). When the tilt angle TA is outside the effective range (No at step S104a), in other words, when the tilt angle TA is smaller than the lower limit value TAmin of the effective range (TA<TAmin) or is larger than the upper limit value TAmax of the effective range (TA>TAmax), the processing circuit 210 stops diffusion degree control (step S105) and re-executes processing at steps S101 to S104a.

When the tilt angle TA is within the effective range (Yes at step S104a), in other words, when the tilt angle TA is equal to or larger than the lower limit value TAmin of the effective range and is equal to or smaller than the upper limit value TAmax of the effective range (TAmin≤TA≤TAmax), the process transitions to the tilt angle-to-diffusion degree conversion processing illustrated in FIG. 26 (step S108a).

In the tilt angle-to-diffusion degree conversion processing illustrated in FIG. 26, the processing circuit 210 determines whether the tilt angle TA acquired by the tilt angle generation circuit 212 is equal to or larger than the upper limit value TArange_max of the diffusion degree adjustment range TArange (TA≥TArange_max) (step S302).

When the tilt angle TA is equal to or larger than the upper limit value TArange_max of the diffusion degree adjustment range TArange (TA≥TArange_max; Yes at step S302), the processing circuit 210 sets the diffusion degree setting value S to the maximum value (Smax=100%) (step S303), and returns to the diffusion degree control processing illustrated in FIG. 25.

When the tilt angle TA is smaller than the upper limit value TArange_max of the diffusion degree adjustment range TArange (TA<TArange_max; No at step S302), the processing circuit 210 subsequently determines whether the tilt angle TA acquired by the tilt angle generation circuit 212 is equal to or smaller than the lower limit value TArange_min of the diffusion degree adjustment range TArange (TA≤ TArange_min) (step S308).

When the tilt angle TA is equal to or smaller than the lower limit value TArange_min of the diffusion degree adjustment range TArange (TA≤TArange_min; Yes at step S308), the processing circuit 210 sets the diffusion degree setting value S to the minimum value (Smin=0%) (step S309), and returns to the diffusion degree control processing illustrated in FIG. 25.

When the tilt angle TA is larger than the lower limit value TArange_min of the diffusion degree adjustment range TArange (TA>TArange_min; No at step S308), the processing circuit 210 converts the tilt angle TA acquired by the tilt angle generation circuit 212 into the diffusion degree setting value S (step S313), and returns to the diffusion degree control processing illustrated in FIG. 25.

When diffusion degree control is not ended (No at step S111) after the transmission-reception circuit 225 transmits the first setting information to the illumination device 1 (step S110), the tilt angle generation circuit 212 acquires the tilt angle TA (step S107a) and the processing circuit 210 re-executes processing at steps S108a to S111.

When diffusion degree control is ended (Yes at step S111), the process returns to the standby state at step S101.

Through the diffusion degree control according to the second embodiment described above, as in the first embodiment, the control device 200 sets a diffusion degree corresponding to the tilt of the control device 200. Accordingly, without operating the screen of the control device 200 held in hand, the user can stably adjust the diffusion degree of the illumination device 1 with one hand, which results in improvement of usability in diffusion degree control of the illumination device 1.

Moreover, in the second embodiment described above, the corresponding range (diffusion degree adjustment range TArange) of the tilt angle TA for the diffusion degree setting value S is set within the effective range of the tilt angle TA in advance. This makes it easier for the user to understand the diffusion degree corresponding to the tilt of the control device 200.

In the aspect exemplarily described in the above-described embodiments, the tilt angle TA is defined as the tilt of the XY plane in the Y direction with respect to a reference plane where the tilt of the XY plane on the illumination control application screen 400 in the Y direction with respect to the RxRy plane is 0 degrees, but the definition of the tilt of the control device 200 is not limited thereto.

Specifically, the tilt angle TA may be defined as, for example, the tilt of the XY plane in the X direction with respect to a reference plane where the tilt of the XY plane in the X direction with respect to the RxRy plane is 0 degrees.

Moreover, the tilt angle TA may be defined as, for example, the tilt of a YZ plane in the Y direction with respect to a reference plane where the tilt of the YZ plane, which is orthogonal to the XY plane on the illumination control application screen 400, in the Y direction with respect to an RyRz plane is 0 degrees, or the tilt angle TA may be defined as, for example, the tilt of an XZ plane in the X direction with respect to a reference plane where the tilt of the XZ plane, which is orthogonal to the XY plane on the illumination control application screen 400, in the X direction an RxRz plane is 0 degrees.

More specifically, in the illumination device 1 in which the light distribution state (diffusion degree) of light incident on the optical element from the light source 4 is controllable in two directions of the Dx direction (first direction) and the Dy direction (second direction) as described above in FIG. 9, for example, a configuration is applicable in which light distribution control in the Dx direction (first direction) corresponds to the rotation angle of the control device 200 about the X axis (refer to FIG. 15A, for example), light distribution control in the Dy direction (second direction) corresponds to the rotation angle of the control device about the Y axis (refer to FIG. 15A, for example), and the control device 200 is rotated about the two axes to control the light distribution state in the two directions. In this case, a configuration is applicable in which the control device 200 is rotated about any one of the axes to control the light distribution state in this direction and then the control device 200 is rotated about the other axis to control the light distribution state in this direction. Another configuration is also applicable in which the rotation angles of the control device 200 about the X and Y axes are simultaneously acquired and the light distribution state is simultaneously controlled in the two directions.

In the above-described embodiments, an aspect is exemplarily described in which a horizontal plane acquired from the detection value of the motion sensor 40 (the gyro sensor 40a, the geomagnetic sensor 40b, and/or the acceleration sensor 40c) is used as a reference plane, but the reference plane as a reference of the tilt angle TA is not limited to the horizontal plane. For example, in calibration of the control device 200, a plane parallel to the XY plane on the illumination control application screen 400 may be set as the reference plane.

The preferable embodiments of the present disclosure are described above, but the present disclosure is not limited to the embodiments. Contents disclosed in the embodiments are merely exemplary and may be modified in various kinds of manners without departing from the scope of the present disclosure. For example, in a case where an illumination device of the present disclosure is controllable by adjusting not only the light distribution shape but also brightness and light color, the configuration of the present disclosure may be used to adjust the brightness and light color. Appropriate modifications made without departing from the scope of the present disclosure naturally belong to the technical scope of the present disclosure.

What is claimed is:

1. An illumination system comprising:
an illumination device controllable with respect to a diffusion degree of light emitted from a light source; and
a control device including a motion sensor and configured to control the diffusion degree of the illumination device in accordance with output from the motion sensor.

2. The illumination system according to claim 1, wherein the control device is configured to
acquire a tilt angle with respect to a predetermined reference plane based on a detection value of the motion sensor and
convert the tilt angle into a diffusion degree setting value of the illumination device.

3. The illumination system according to claim 2, wherein
an effective range of the tilt angle is set in the control device, and
the control device is configured to, when the tilt angle is within the effective range, start diffusion degree control of the illumination device.

4. The illumination system according to claim 3, wherein
diffusion degree adjustment range of the illumination device is set in the effective range in the control device, and
the control device is configured to
set the diffusion degree setting value to a maximum value when the tilt angle is equal to or larger than an upper limit value of the diffusion degree adjustment range, and
set the diffusion degree setting value to a minimum value when the tilt angle is equal to or smaller than a lower limit value of the diffusion degree adjustment range.

5. The illumination system according to claim 3, wherein the control device is configured to
acquire, as a diffusion degree initial value, the diffusion degree of the illumination device before the diffusion degree control is started,
acquire, as a tilt angle initial value, the tilt angle when the diffusion degree control is started, and
set a diffusion degree adjustment range of the illumination device by associating the diffusion degree initial value with the tilt angle initial value.

6. The illumination system according to claim 5, wherein the control device is configured to
set the diffusion degree setting value to the maximum value when the upper limit value of the diffusion degree adjustment range is smaller than an upper limit value of the effective range and the tilt angle is equal to or larger than the upper limit value of the diffusion degree adjustment range, and
set the diffusion degree setting value to a minimum value when a lower limit value of the diffusion degree adjustment range is larger than a lower limit value of the effective range and the tilt angle is equal to or smaller than the lower limit value of the diffusion degree adjustment range.

7. The illumination system according to claim 6, wherein the control device is configured to
convert the upper limit value of the effective range into the diffusion degree setting value when the upper limit value of the diffusion degree adjustment range is equal to or larger than the upper limit value of the effective range and the tilt angle is equal to or larger than the upper limit value of the effective range, and
convert the lower limit value of the effective range into the diffusion degree setting value when the lower limit value of the diffusion degree adjustment range is equal to or smaller than the lower limit value of the effective range and the tilt angle is equal to or smaller than the lower limit value of the effective range.

8. The illumination system according to claim 2, wherein the diffusion degree setting value increases as the tilt angle increases.

9. The illumination system according to claim 8, wherein the diffusion degree setting value linearly changes with a change of the tilt angle.

10. The illumination system according to claim 8, wherein a change rate of the diffusion degree setting value increases as the tilt angle increases.

11. The illumination system according to claim 2, wherein
the illumination device is adjustable with respect to a light distribution shape of light emitted onto a virtual plane in two directions of a first direction and a second direction intersecting the first direction, by controlling a diffusion degree of light emitted from a light source,
an X direction corresponding to the first direction and a Y direction corresponding to the second direction are defined in the control device,
the control device is configured to control the diffusion degree of the illumination device in the first direction based on the tilt angle in the X direction with respect to the reference plane, and
the control device is configured to control the diffusion degree of the illumination device in the second direction based on the tilt angle in the Y direction with respect to the reference plane.
